(19) United States
(12) Patent Application Publication
(10) Pub. No.: US 2014/0020312 A1
(43) Pub. Date: Jan. 23, 2014

(54) WINDOWS AND DOORS HAVING INTEGRATED SOLAR POWERED CHARGING DEVICES

(71) Applicants: Kevin A. Seiling, Monaca, PA (US); William G. Roberts, Beaver Falls, PA (US); Thomas J. Fejka, Beaver Falls, PA (US)

(72) Inventors: Kevin A. Seiling, Monaca, PA (US); William G. Roberts, Beaver Falls, PA (US); Thomas J. Fejka, Beaver Falls, PA (US)

(21) Appl. No.: 13/552,383

(22) Filed: Jul. 18, 2012

(51) Int. Cl. E06B 7/28; E04B 1/38

(52) U.S. Cl. 52/173.3; 52/698

(57) ABSTRACT

An integral energy collector and charging system is provided in windows, associated screens and doors so as to facilitate harvesting of solar energy through solar energy collectors unique distribution channels for employing such energy to charge storage batteries which, in turn, provide energy to power outlets. The power outlets may be accessed in order to charge various types of devices. The system is employable with a wide variety of window and door constructions.

### BACKGROUND OF THE INVENTION

1. Field of the Invention

The present invention relates to improved means for efficiently integrating solar powered charging devices into windows and doors and, more specifically, it relates to such systems which may be employed with a variety of windows and doors and may be used to energize a wide variety of devices.

2. Description of the Prior Art

It has been known to have solar collectors absorb the sun's rays and convert the sun's energy into electrical output for various uses.

United States Patent Application Publication No. US 2008/0125188 discloses a cellular phone case which includes a solar cell and associated circuit board and a battery board which is electrically connected to the circuit board. A socket for providing electrical input into the battery or obtaining output of electrical energy from the battery is disclosed.

United States Patent Application Publication No. US 2008/0200221 discloses a solar panel for charging a battery which is operatively associated with a mobile communications device.

United States Patent Application Publication No. US 2007/0278989 discloses a solar charged battery within a power supply which is structured to charge objects such as cell phones, personal digital assistance and portable personal computers.

U.S. Pat. No. 5,905,356 discloses a solar powered charger for vehicle accessories and cordless tools such as cellular phones.

U.S. Pat. No. 7,777,128 discloses a pair of mechanical or electrical photovoltaic cells each having an electrode for use in a wide variety environments, including windows, but provides no details regarding the specific end use applications.

U.S. Pat. No. 6,608,464 discloses solar cells which are laminated onto a rechargeable energy source such as a solid state polymer battery which in turn may be operatively associated with circuits which manage battery charging. See also, U.S. Pat. No. 7,781,672.

United States Patent Application Publication No. US 2011/0083719 discloses a dye-sensitized solar cell which functions both as a solar cell and a display unit. The solar cell unit is said to charge a storage battery which provides energy to a light source. Attaching the solar cell to a window is suggested. A mobile device such as a mobile phone handset is also disclosed.

United States Patent Application Publication No. US 2010/0294354 discloses a patterned photovoltaic device which has predetermined openings and may be mounted in a window of a building to provide a decorative function.

Chinese Patent CN20139201 discloses a solar window for a steamship. A solar battery board is provided on the glass surface of the window main body. The solar battery board converts the optical energy to power, which is stored in a storage battery, with the electrical output thereof serving to energize apparatus such as mobile phones.

Chinese Patent CN201714229 discloses a solar window which cooperates with solar battery panel on the illuminated side of a window frame with the battery panel being connected to a storage battery through a charging controller. The storage battery is also said to be connected to a USB charging socket.

United States Patent Application Publication No. US 2008/0236654 discloses a window which incorporates a thin-film photovoltaic system for converting solar energy into electrical energy. A controller is connected to the photovoltaic system and to the building power grid to energize devices used within the building.

French Patent No. FR2829633 discloses a solar screen contained within a housing which includes a liquid crystal screen able to display a charge indicating light emitting diode along with a cut-off switch. The housing has a charging cable fitted with a mobile phone charging connector.

United States Patent Application Publication No. US 2009/0058354 discloses a solar-powered media system which includes a docking station for holding an iPod.

United States Patent Application Publication No. US 2004/0204179 disclosed a multi-socket solar energy system for charging a battery which is capable of energizing a mobile phone.

United States Patent Application Publication No. US 2011/0023931 discloses a solar energy system which has adjustment means for altering the angle of the solar panel. It also discloses a battery 21 for storing electrical power and a USB socket.

United States Patent Application Publication No. US 2009/0173008 discloses the use of a photovoltaic charging driving device to move the slats of a shutter to various positions.

United States Patent Application Publication No. US 2011/0095719 discloses a photovoltaic array with a border surrounding the same and an outlet. The array is connected to a battery and transfers electrical energy thereto.

United States Patent Application Publication No. US 2011/0228520 discloses a skylight which has a solar panel array which is associated with a rechargeable power source and a plurality of lighting elements to illuminate the floor of a building.

United States Application Publication No. US 2011/0265694 discloses a solar powered umbrella table which energizes batteries. It also discloses the use of an inverter to convert DC voltage output from the batteries to 120 volts AC.

United States Patent Application Publication No. US 2011/0273133 discloses a solar USB charger which is said to provide energy without use of an internal battery for purposes of charging electronic devices such as iPods, and iPhone. Reference is made to optional rechargeable battery use.

U.S. Pat. No. 4,539,516 discloses a solar cell for recharging button batteries.

U.S. Pat. No. 4,717,790 discloses a laminated solar cell having an elastic thermosetting adhesive foil and a glass pane. It contemplates the device being curved to accommodate the shape of the window of an automobile, home or boat.

U.S. Pat. No. 4,830,038 discloses an encapsulated photovoltaic panel which has a plug for delivering electricity to an external device.

U.S. Pat. No. 5,221,363 discloses solar cells mounted in a window which has a pair of transparent glass panes between which a window blind is mounted. The solar cells are disposed on the slats of the window blind in order to obtain exposure to sunlight. Batteries are mounted on the slats and delivery of energy to a power bus is disclosed.

U.S. Pat. No. 5,741,369 discloses a plate-like structure with a solar battery for a sound insulation wall. This is designed to provide a source of electricity along a highway.

U.S. Pat. No. 6,063,996 discloses a solar cell module having a plurality of photovoltaic elements mounted on a roof to provide a source of electricity for possible use in connection with a heat collecting panel.

U.S. Pat. No. 6,326,764 discloses a solar system for energizing a CD player. The solar panel is adjustable with respect to the angle of the sun's rays. The energy absorbed is said to be usable either directly or in recharging a battery.

U.S. Pat. No. 6,617,822 discloses a system which has a solar collector, appropriate wiring and a storage battery. It is designed for use on a vehicle and cooperates with the vehicle battery.

U.S. Pat. No. 6,646,196 discloses a multi-paneled window having at least one of the panels provided with a plurality of solar panels. Wiring connects the photovoltaic panel with a battery which is to be recharged. DC and AC embodiments are disclosed.

U.S. Pat. No. 6,762,582 discloses a solar device which is said to permit powering of an electric-powered device such as a vehicle. See also, U.S. Pat. No. 6,856,116 which states that the electric power generated by each solar source is independently communicated to a battery.

U.S. Pat. No. 7,565,968 discloses a portable survival kit which employs a solar panel and a pair of rechargeable energy sources.

U.S. Pat. No. 8,018,098 discloses a portable solar power system wherein energy is delivered to a control block for storing the power. The use of a USB interface as well as a DC power output interface is disclosed. U.S. Pat. No. 8,129,938 discloses a system which employs a solar energy to supply power to a portable device.

U.S. Pat. No. 8,041,029 discloses a mount for an electronic device to be mounted on a vehicle dashboard. It contains a solar cell and a battery system which operates a navigation device.

U.S. Pat. No. 8,080,972 discloses a system for storing and releasing energy. A rechargeable battery unit is associated with a solar panel wherein the alternative AC adapter which is plugged into a wall outlet.

Korean Patent 20020012883 discloses a portable electronic solar cell system with an enlarged solar collector.

Chinese Patent Application 20072006228 discloses a portable solar electric source.

Japanese Patent 2010-104155 discloses a charger for a portable electronic apparatus such as a cellular phone, a digital camera or a portable game machine. A solar panel is said to charge a secondary battery with the charging unit said to provide an AC connector socket with a reference to a “USB connector socket.

Japanese Patent 58197781 discloses a window having optical battery panels arranged to effect rotation of slats to align the same with the source of solar light.

There remains a very real and substantial need for improved means of providing as an integral component of windows and doors an energy collecting, storing and delivery system usable on a wide variety of windows and doors and an energizing a number of different types of electricity consuming devices.

### SUMMARY OF THE INVENTION

It is an object of the present invention to provide a window or door mounted solar system employable to charge a battery(s) which in turn may energize a product through the use of a “USB” port or other means.

It is a further object of this invention to provide such a system which may be employed in new construction, replacement windows and doors, and field application.

It is yet another object of the present invention to provide such a system which is usable on both residential and commercial windows and doors.

It is another object of the invention to provide such a system for windows and doors which serves to reduce the cost of wiring electrical outlets for a building, reduce fire hazards and increase the convenience of use.

It is yet another object of the present invention to provide such a system which may be employed on windows and doors made from wood, aluminum, steel, vinyl, fiberglass and composites.

It is yet another object of the present invention to provide such a system which is usable with movable and fixed pane windows as well as screens which are employable with the same.

It is yet another object of the present invention to provide such solar energy systems which are economical to install, durable and economical to use.

These and other objects of the invention will be more fully understood from the following description of the invention on reference to the illustrations appended hereto.

The invention provides a window or door having an integral energy collector and charging system. It provides for one or more solar collectors to be positioned on the exterior of the window or door and a rechargeable battery operatively associated with a power outlet such as an USB port disposed on the interior of the window or door. Depending on the construction of the window or door, various designs for providing electrical conductors connected to the solar collector and to the battery to facilitate charging of the battery for delivery to the power outlet which may be a USB port.

The solar collector may have an upper portion secured to the window or door and extend angularly, downwardly and outwardly so as to facilitate efficient collection of solar energy. A protective bellows element may be provided to resist undesired entry of insects and foreign matter into the solar collector system. A protective cage may be positioned around the exterior of the solar collector to resist tampering of the same.

The solar collector may be secured to framing portions of the windows or doors, glass or other panel portions of the windows or doors with the electrical conductors passing through hollow framing members where the window or door construction is appropriate for that treatment.

The solar collector may be secured to a screen associated with a window or door.

The solar collector system of the present invention is suitable for both residential and commercial construction and may be manufactured as part of the original window or door construction or may be retrofit into existing structures.

Where a movable sash is involved, one or more solar collectors may be provided on the movable sash and one or more solar collectors may be provided on the frame therefor.

### BRIEF DESCRIPTION OF THE DRAWINGS

FIG. 1 is a front elevational view of a rotatable window of the present invention.

FIG. 2 is a cross-sectional view of the window of FIG. 1 taken through 2-2.

FIG. 3 is a cross-sectional illustration of the window of FIG. 1 taken through 3-3.

FIG. 4 is an elevational view of a form of storage battery and power outlet combination of the present invention.

FIG. 5 is a left-hand elevational view of FIG. 4 of the present invention shown without the cover in place.

FIG. 6 is an elevational view of the battery/preferred USB structure with the cover in place.

FIG. 7 is an alternate embodiment of the storage battery housing showing two end-to-end storage batteries with two USB access ports.

FIG. 8 is a front elevational view of a multi-pane window having a solar collector system installed within a window screen.

FIG. 9 is a cross-sectional view taken through 9-9 of FIG. 8 showing a portion of the solar collector device.

FIG. 10 is a detailed elevational view showing a portion of the solar collector and related screen.

FIG. 11 is a front elevational view of a storefront having a plurality of fixed panels and a plurality of solar collectors.

FIG. 12 is a fragmentary illustration in elevation partially in section showing a portion of the storefront collector layout of FIG. 11.

FIG. 13 is a cross-sectional illustration showing a portion of the storefront solar collector layout of FIG. 11 in vertical section.

FIG. 14 is a front elevational view from the exterior of a building showing a window having a fixed lite with two panes of glass and a lower movable sash with two panes of glass.

FIG. 15 shows a horizontal section taken through 15-15 of FIG. 14.

FIG. 16 is a vertical cross-sectional view taken through 16-16 of FIG. 14.

FIG. 17 is a front elevational view from the building interior of a swing door having two solar collector systems of the present invention.

FIG. 18 is a vertical cross-section of the rotating or swing-door of FIG. 17 designed for in-swing or rotation into the room.

FIG. 19 is a vertical section of a rotating or swinging door designed for out-swing or rotation to the outside.

FIG. 20 is a front elevational view of a window having two fixed lites and a solar collector secured therebetween.

FIG. 21 is a cross-sectional illustration taken through 21-21 of FIG. 20.

FIG. 22 is a front elevational view of a single hung window having a screen and solar collector operatively associated with the screen.

FIG. 23 is a cross-sectional view of the window-screen-solar collector assembly of FIG. 22 taken through 23-23.

FIG. 24 is a cross-sectional view of the window-screen-solar collector assembly of FIG. 22 taken through 24-24.

FIG. 25 is a cross-sectional view of the window-screen-solar collector assembly of FIG. 22 taken through 25-25.

FIG. 26 is elevational view partially exploded showing the solar collector components and screen.

FIG. 27 is a front elevational view of a base member to which the solar collector is secured.

FIG. 28 is a cross-sectional view through 28 of 28.

FIG. 29 is a front elevational view of the back up member of FIGS. 27 and 28.

FIG. 30 is a perspective view of a solar collector support for use in an adjustable angle system.

FIG. 31 is a front elevational view of the support of FIG. 30.

FIG. 32 is a top plan view of the support of FIG. 30.

FIG. 33 is a right side elevational view of the support of FIG. 30.

FIG. 34 is a perspective view of a first component of a two component bracket for use with the support of FIG. 30.

FIG. 35 is a front elevational view of the support component of FIG. 34.

FIG. 36 is a top plan view of the support component of FIG. 34.

FIG. 37 is a right side elevational view of the support component of FIG. 35.

FIG. 38 is a perspective view of the second frame component to be used with the frame component of FIG. 34 in supporting the solar collector support of FIG. 30.

FIG. 39 is a front elevational view of the support component of FIG. 38.

FIG. 40 is a top plan view of the support component of FIG. 39.

FIG. 41 is a right side elevational view of the support component of FIG. 39.

FIG. 42 is a front elevational view of the window having additional electrical options.

FIG. 43 is a left side elevational view of the window of FIG. 42.

FIG. 44 is an exploded view showing the component parts for establishing the solar collector as a rotatable solar collector.

FIG. 45 is a top view showing the assembled rotatable solar collector.

FIG. 46 is a perspective view showing the assembled solar collector.

FIG. 47 is a perspective view of a double sash window.

FIG. 48 is a perspective view showing an anchor for securing a solar collector assembly to a mullion.

FIG. 49 shows a perspective view of a solar collector support secured to the anchor of FIG. 48.

FIG. 50 shows a perspective view of the solar collector and support assembly.

FIG. 51 shows a turn and tilt window in the closed position.

FIG. 52 shows a cross-sectional illustration of the tilt and turn window of FIG. 51 taken through 52-52.

FIG. 53 shows the turn and tilt window of FIG. 51 with the window in a turned opened position.

FIG. 54 is a cross-sectional view taken through 54-54 of FIG. 53 showing the turned open position of the tilt and turn window.

FIG. 55 shows the window of FIG. 51 tilted open.

FIG. 56 is a cross-sectional view taken through 56-56 of FIG. 55 showing the tilted open position.

FIG. 57 is a vertical cross-sectional illustration of the tilt and turn window similar to FIG. 52, but showing the solar collector the associated wiring and the storage battery.

FIG. 58 is a horizontal cross-sectional view showing the window of FIG. 57 with the solar collector, wiring, associated battery and USB port.

### DESCRIPTION OF THE PREFERRED EMBODIMENTS

The windows with which the solar powered charging systems of the present invention may be employed may be of a wide variety of constructions. More specifically, the windows may have single, double or triple panes. Also, the frames may be made of any suitable materials such as aluminum, steel, vinyl, fiberglass, wood and composites. The system is readily employed in residential as well as commercial structures. The system may also be employed in new construction, replacement windows as well as field application of the device to pre-existing windows. The system is also usable with doors.

As used herein, the word “exterior” refers to the outside of a building or other structure having a window, window assembly or door of the present invention.

As used herein, the term “interior” refers to the building interior side window of a window assembly or door provided in a building or other structure.

As used herein the term “power outlet” refers to single power outlet or multiple power outlets energized by a storage battery and accessible for purposes of charging a device.

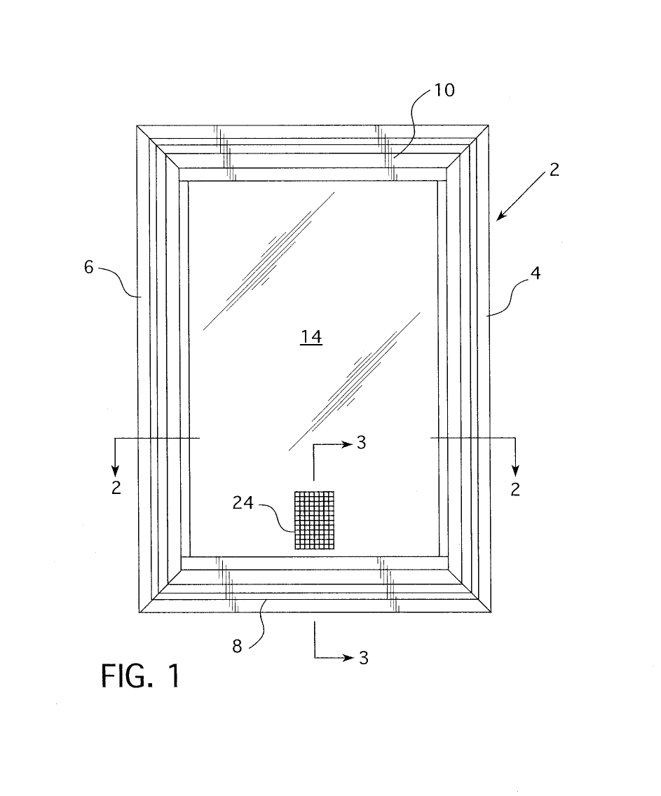

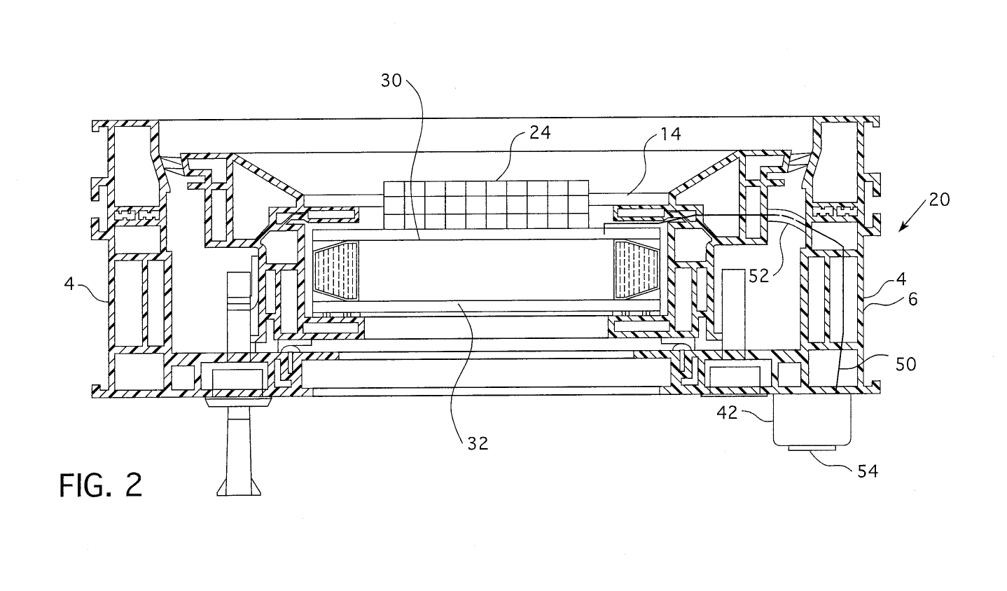

Referring to FIGS. 1 through 2, there is shown a rotatable window which in the form illustrated is structured to rotate about a vertical axis. The concepts of this embodiment are equally employable with windows which are rotatable about a horizontal axis with appropriate positioning of the solar collector in a manner which will be known to those skilled in the art based upon the disclosure regarding FIGS. 1-3.

FIG. 1 shows a vinyl casement window which has a generally rectangularly frame 2 which in the form illustrated is made from vinyl extrusion sections. The frame 2 has a pair of jambs 4 and 6, a sill 8, and a header, 10.

The window in the form shown is a casement window which has a rotatable sash 14 which is rotatable about a vertical hinge 20 as shown in FIG. 2. The hinge is on the right side and the sash 14 would rotate outwardly in a generally clockwise direction. The solar collector 24 is secured to the outer surface 26 of the forwardmost 30 of the two panes of glass contained within the sash 14. The solar panel 24 has its upper edge 36 secured to glass pane 30 by any suitable means such as by an adhesive or mechanical fasteners such as screws, rivets or nuts and bolts, for example.

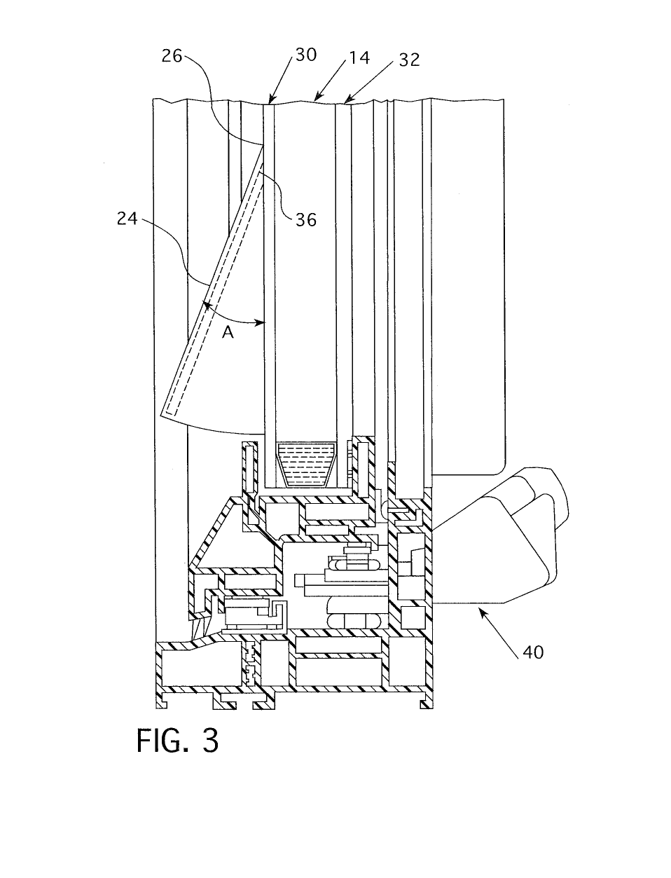

In the form shown, the solar panel 24 extends angularly downwardly and outwardly at a smaller included angle A (FIG. 3) of about 1 to 90 degrees.

This range of angles A is preferred in order to maximize the efficiency of collection of the solar energy by the solar collector 24.

For convenience of shipment, the solar collector may be initially provided may be rotated inwardly in general surface to surface contacts through 3 with the outer surface of glass pane 30. Upon installation, the solar collector will be rotated outwardly to the desired position.

In the form shown in FIGS. 1-3, the window is a casement window which is caused to rotate through operation of the crank assembly 40 in a conventional manner. A preferred combination storage battery and power outlet unit 42 is, in the form shown, attached to the interior surface of jamb 6. An electrical conductor which in the form shown is wire 50, is connected at one end to the solar panel and passes through a flexible plastic tube 52 in order to provide electrical energy created responsive to the solar collector absorbing solar light to charge the storage battery(s), which in turn, is structured to charge whatever device is subsequently connected to it through the power outlet 54. The batteries are preferably AA rechargeable storage batteries and may if desired be wired in series with each other or in parallel. As a function of the size of the solar collector, one may generally employ one to three batteries. One of the advantages of the present system is that a net zero energy window could be provided such that a very large solar collector would supply all of the devices which are to be charged such as USB ports, charging pads, portable batteries and rechargeable batteries. If desired, the USB ports may be retractable. The invention is not limited to the use of AA rechargeable storage batteries, but dependent upon the electrical needs may be other types of batteries and combinations thereof. The power outlet may conveniently be a USB port.

If desired, the frame and sash could each have cooperating electrical components such that the circuit would be completed when the window is in a closed position.

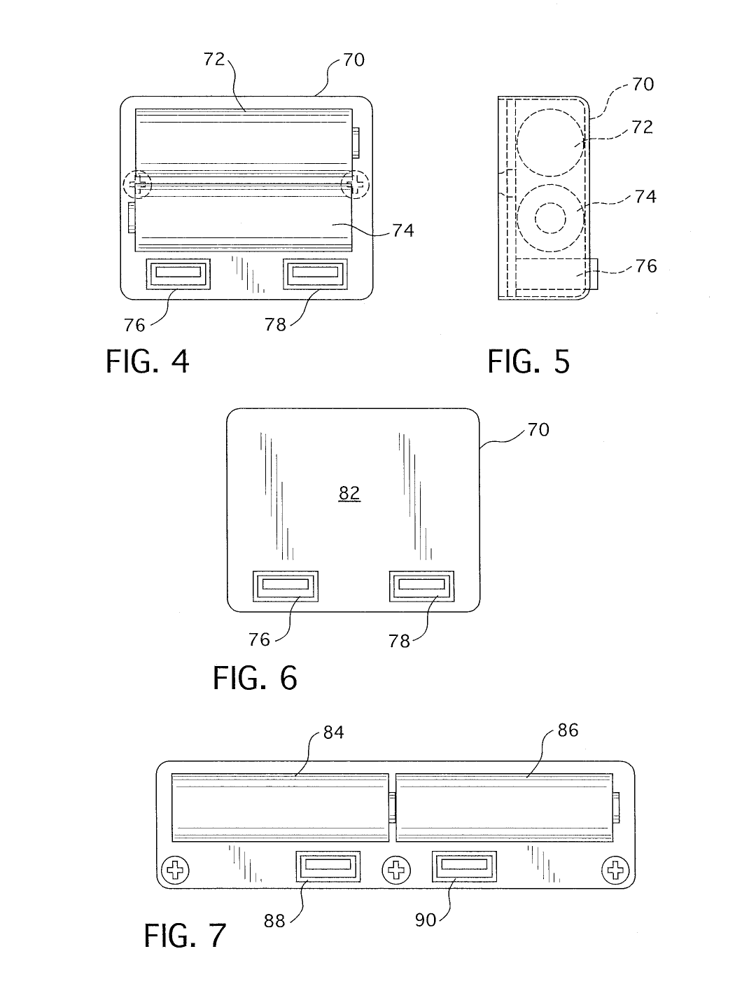

Referring to FIGS. 4 and 5, there is shown a housing 70 containing a pair of storage batteries 72, 74 which are electrically connected to the solar collector 24 through wire 50 in a conventional manner (not shown in this view). The storage batteries 72-74 each serve to energize a power outlet 76, 78, respectively, through conventional wiring (not shown). The assembly shown is shown with its cover 82 in place in FIG. 6. It will be appreciated that, in this manner, the solar collector 24 receives light, converts it to electricity, which through wire 50 is delivered to and charges storage battery 72,74 with access to charging a device being obtainable through power outlets 76, 78. The batteries 72, 74 are preferably contained within a protective housing, such as housing 70, and also may be placed within a void within the window frame as contrasted with projecting outwardly from the inside of the window.

FIG. 7 shows an alternate embodiment for a housing for the storage batteries and the power outlets, which, in the form shown, are USB ports. The batteries 84, 86 are shown in side by side relationship as contrasted with vertically stacked arrangement of FIGS. 4 and 5 with the associated USB ports 88, 90. This embodiment is better suited to use with window and door structures which have a low sill height.

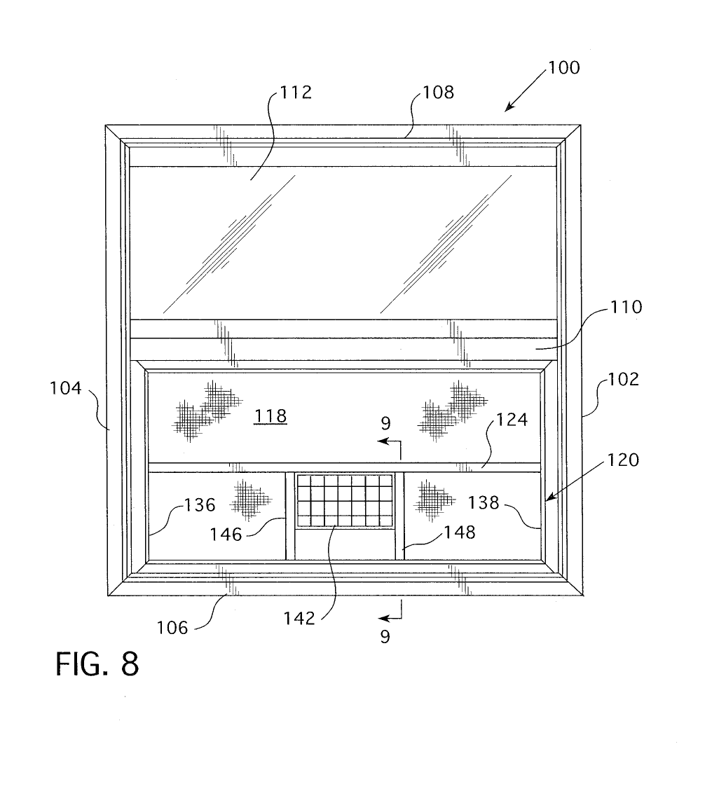

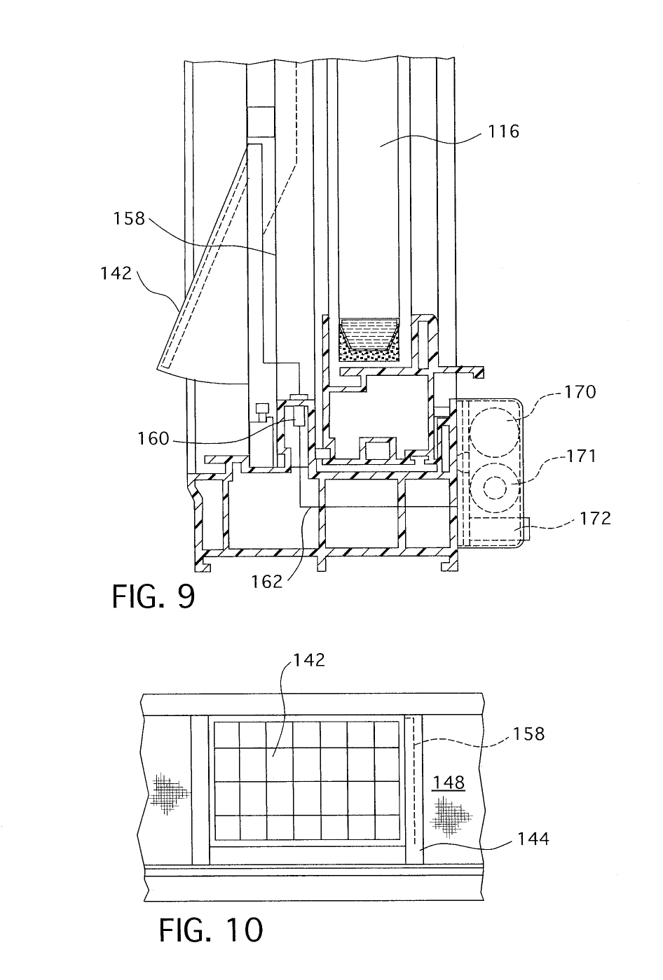

FIGS. 8 through 10 show a front elevational view of a window 100 having a frame consisting of a pair of extruded jamb sections 104 to which a rail 106 is joined at the lower extremity and a header 108 is joined at the upper extremity. A fixed lite 112 is disposed over a moveable sash 116 (FIG. 9). Mullion 110 is interposed between fixed lite 112 and sash 116. A screen 118 has a frame 120 and a rail 124 having opposed ends fixedly secured to screen frame members 136, 138. A solar collector 142 is fixedly secured to the screen by support members 146, 148. As shown in FIGS. 9 and 10, tubular support 148 is hollow and has a wire 158 which is connected to the solar collector 142 for delivery of electrical current from the solar collector 142 to electrical connector 160 and through wire 162 to the storage battery 170 and USB port 172. It will be appreciated that, in this manner, efficient delivery of electricity generated by the solar panel 142 is delivered through wires 158 connector 160, wire 162 to the storage battery to charge the same with the battery in turn providing energy for the USB port 171. The sash window 116 may be reciprocated vertically without mechanical interference with the solar collector system.

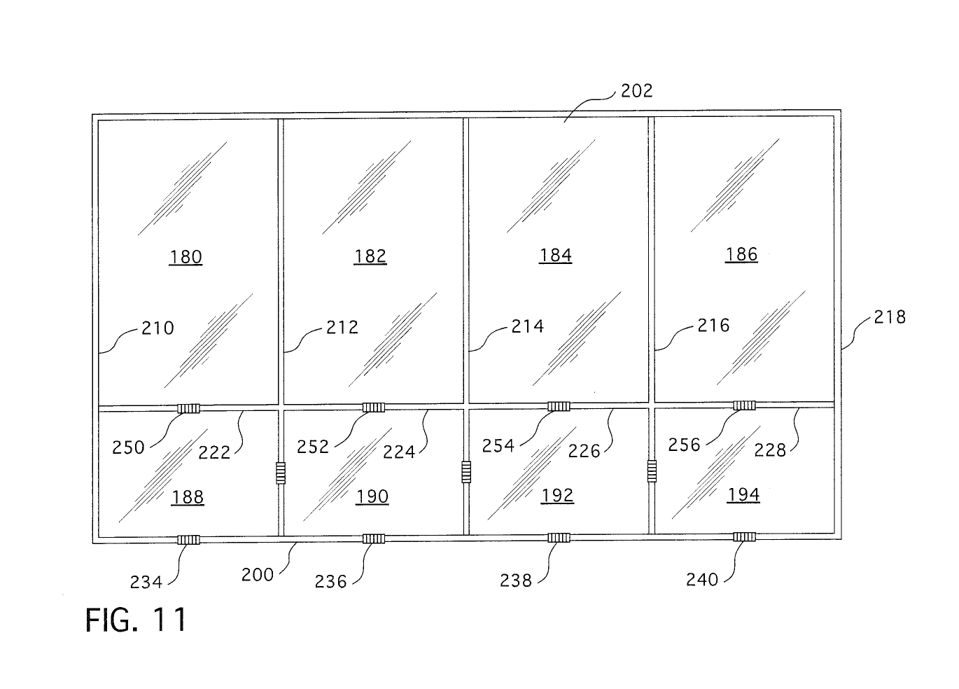

Referring to FIG. 11, there is shown a storefront assembly of a plurality of fixed panels 180, 182, 184, 186, which overlie respectively a second plurality of fixed panels 188, 190, 192, 194. These panels may be windows or decorative panels of various sorts, for example, and be made of various materials. The framing members consist of a sill 200 and header 202 with a plurality of vertical support elements 210, 212, 214, 216. A plurality of rail elements 222, 224, 226, 228 are secured respectively to framing members 210 to 212, and 212 to 214 and 214 to 216 and 216 to 218. While the framing members may be made of any material possessing the desired strength, durability and other properties for purposes of example, in the present context, they will be considered as being aluminum extrusions which are connected to each other in any suitable conventional manner. A plurality of solar collectors 234, 236, 238, 240 of the present invention are secured to rail 200 at spaced locations and are generally centrally located underlying respectively panels 188, 190, 192, 194. Similarly, solar collectors 250, 252, 254, 256 are respectively interposed between panels 180, 188, and 182, 190 and 184, 192 and 186, 194. This provides this collector wall with eight distinct independent solar collectors for charging their respective storage batteries and permitting a device to be charged to have access to each of the power outlets such as USB ports.

If desired, the output from the various solar collectors may be connected to one or more electrical bus members to provide an efficient means of delivering the electrical energy to the electrical outlets.

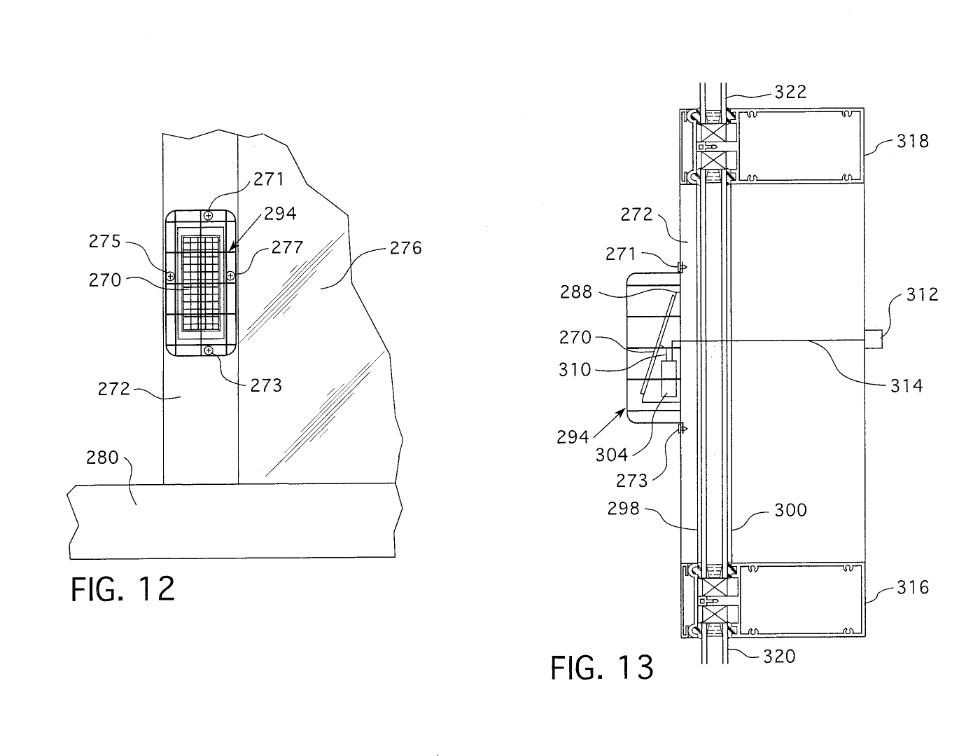

Assuming for purposes of illustration that the panels are glass panels, with reference to FIGS. 12 and 13 additional features of the invention will be considered.

The solar panel 270 is secured to a vertical framing member 272 and extends downwardly and outwardly therefrom. For security purposes, a wire cage 294 has been shown as being protectively surrounding the solar collector 270 so as to resist efforts to vandalize the same. This cage may be secured to vertical framing member 290 by any suitable means, such as screws 271, 273, 275, 277.

As shown in FIG. 13, the fixed window consists of two panes 298, 300.

In the embodiment as shown in FIG. 13, the storage battery 304 is disposed on the exterior of the panels 298, 300 and closely behind the solar collector 270. An electrical conductor which in the form shown is a wire 310, delivers electricity from the solar panel 270 to the storage battery 304. The USB power outlet 312 is secured to the interior of rear surface of the mullion 290 and is connected to the storage battery 304 by wire 314 which passes through the mullion.

Horizontally oriented hollow aluminum extrusions rails 316, 318 respectively support underlying two pane window 320 and overlying two pane window 322. It will be appreciated that in this embodiment, the storage battery has been positioned exteriorly of the structure and the USB power outlet interiorly. Also, a vandal resistant wire basket 294 has been positioned around the solar collector 270 and storage battery 304.

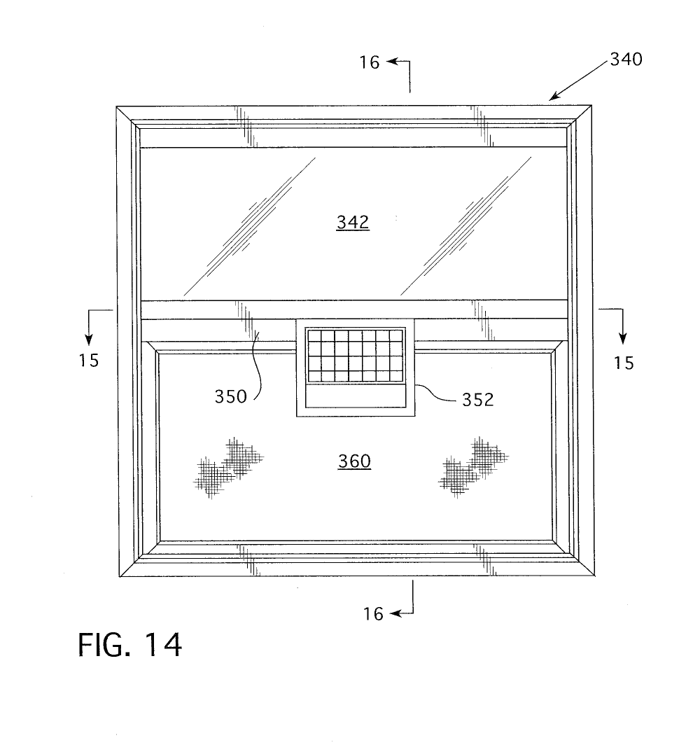

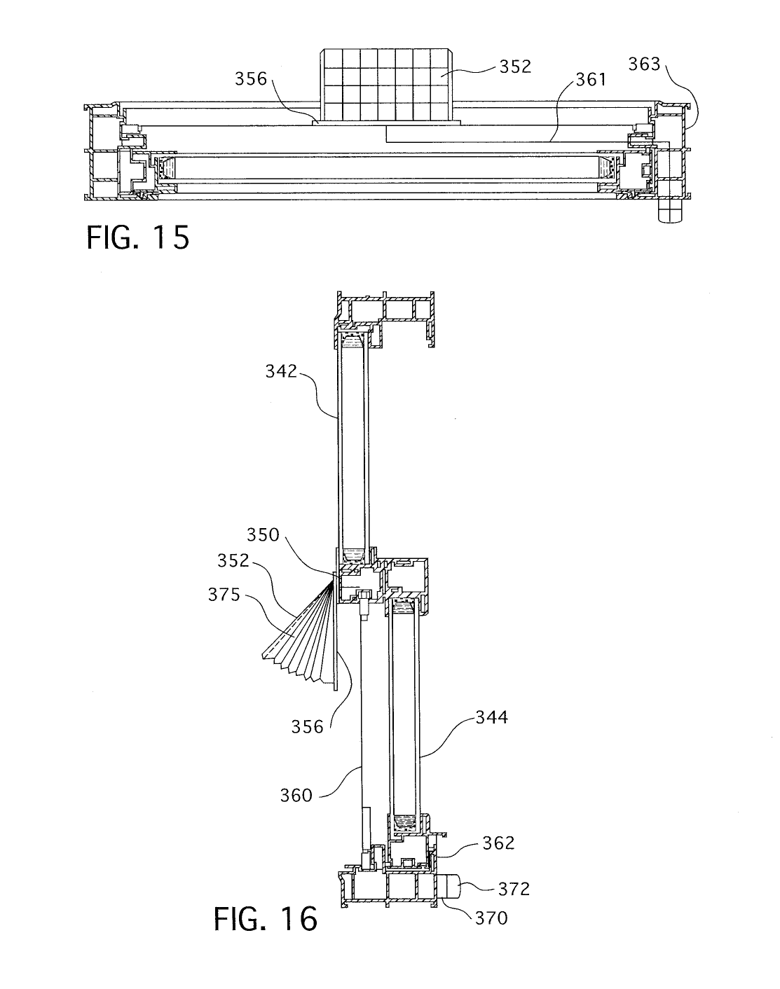

Referring to FIGS. 14 through 16, there is shown a window frame 340 having a fixed lite 342 and a movable sash 344 with a hollow rail 350 to which a solar collector 352 is secured by and is generally coextensive with a support plate 356 which in turn is secured to the hollow rail 350, an electrical wire 361 which is connected to the solar collector 352 extends through hollow rail 350 and downwardly through frame 363 and is electrically connected to the storage battery 370 which in turn energizes the USB port 372.

Another feature of this embodiment of the invention is the bellows type housing 375 (FIG. 16) which allows for adjustment of the position of the solar collector and collapse of the same toward support plate 350 for shipment. The bellows may be made of any suitable material such as polyvinyl chloride, polycarbonate, nylon, or metal, for example.

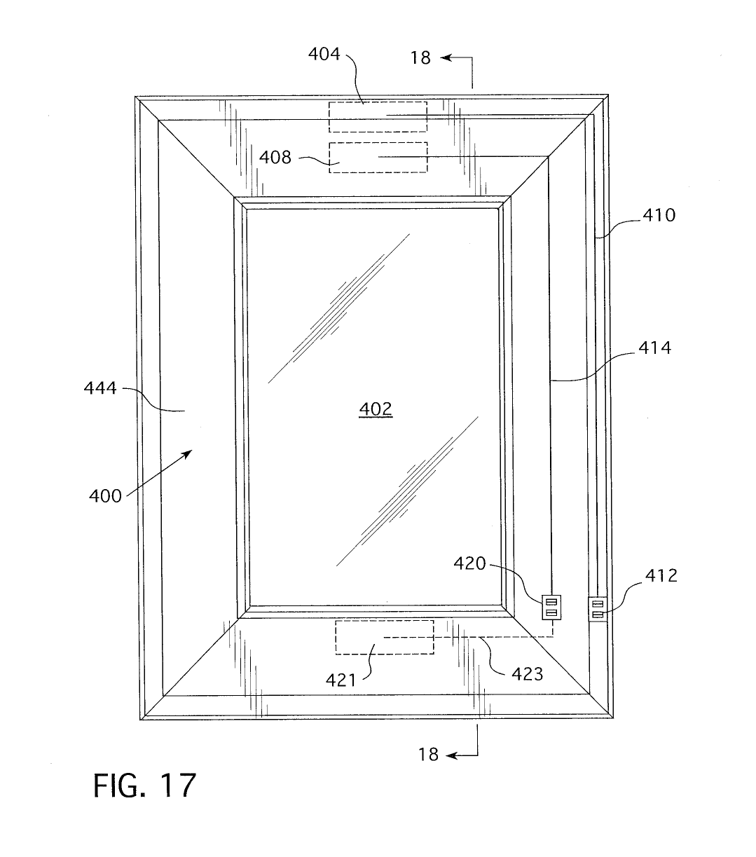

FIGS. 17 through 19 relate to a rotating a swing-door 400. FIG. 17 shows a front elevational view from the interior of the building. The door has a rotatable sash 402 fixed to the frame for rotation therewith. In the embodiment shown, the system has three solar collectors, one of which 404 is secured to the door frame, and the others of which 408, 420 are secured to the door sash. Solar collector 404 collects solar energy and, by means of wire 410, delivers the energy to the battery (not shown) which is disposed rearwardly of the two USB power outlets 412 which are energized by the battery. Depending upon the electrical power requirements, each of the solar collectors, 404, 408, 421, would be associated with one of the two USB power outlets with each of the two USB power outlets 412, 420 being energized by a separate battery or batteries. In this manner, someone on the inside of the building can readily access the two USB power outlets to employ the electrical energy resulting from the exteriorly disposed solar panel 404. Similarly, exteriorly positioned solar panel 408 delivers current through wire 414 to the storage battery (not shown) but positioned rearwardly of the two USB power outlets 420. Wires 410 and 414 are disposed on the interior of the door frame. A second solar collector 421 may be positioned on the sash at the lower end thereof on the exterior and through an external wire 423 deliver electrical energy to the battery (not shown) which is behind the USB port 424 and energizes the same. It will be appreciated that for a given installation, more or less than the number of solar collectors 404, 408 and 421 shown in FIG. 17 may be used and, depending upon preference, could be positioned on the frame or the sash over both.

It will be appreciated that similar systems as disclosed and illustrated in connection with the doors of FIG. 17 through 19 may be employed with tilt and turn Window and door constructions.

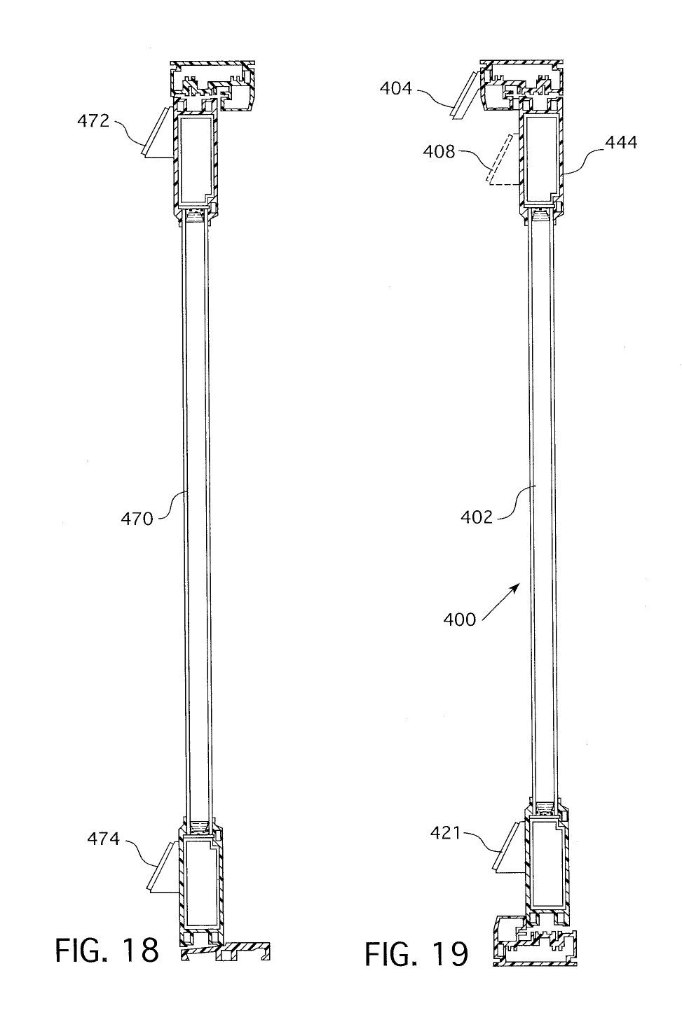

FIG. 18 shows in section the construction for the door 400 of FIG. 17 which is structured to swing into the building. It has sash 402 secured within a frame 444, a sash mounted solar collector 408 is secured exteriorly of the door as is a frame mounted solar collector 404. A second sash mounted solar collector 421 is at the lower end of the sash 402. The electrical energy provided by solar collectors 404, 408, 421 are presented to the storage batteries which in turn energize the USB power outlets.

Referring to FIG. 19, this illustrates an out-swinging vertical section with the sash 470 having an upper solar collector 472 secured to the exterior thereof and a second solar collector 474 secured to the exterior at the lower end of sash 470. Wired connections and the storage batteries being charged thereby along with the USB power outlets which they energize may be similar to those discussed in connection with FIG. 17. As was true with respect to FIG. 17, the number and positioning with the solar collectors 404, 408, 421, 472, 474 may be varied in terms of number, positioning on the sash, the frame or both, depending upon the design perimeters employed.

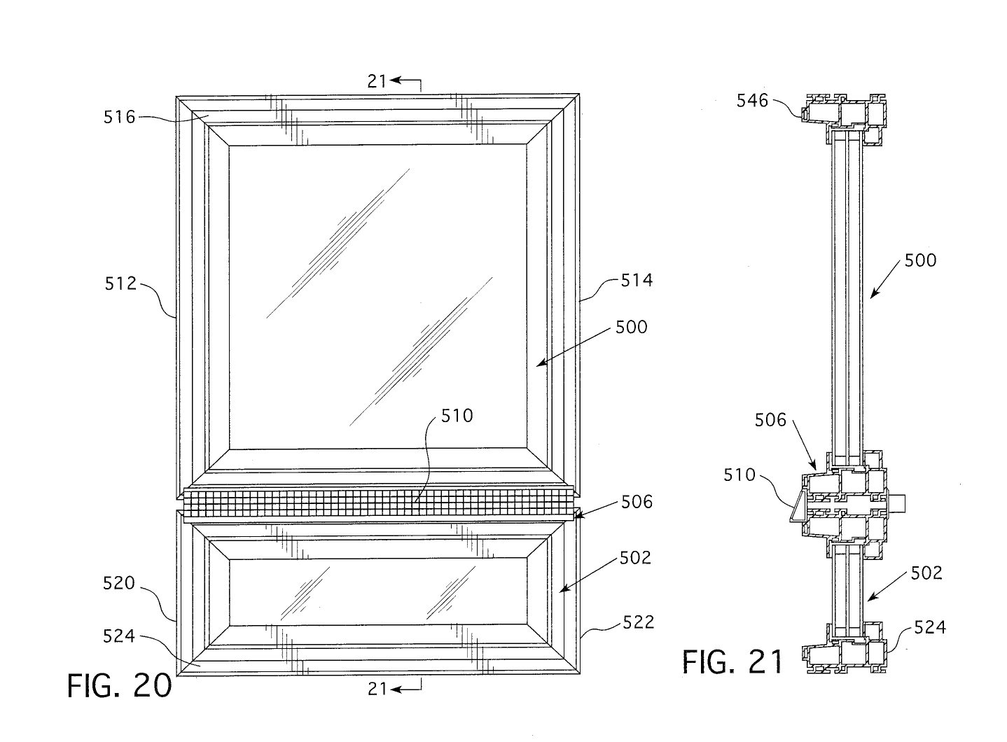

Referring to FIGS. 20 and 21, there is shown a window assembly having an upper window 500 and a lower window 502 and a mullion 506 is disposed in between upper window 500 and the lower window 502. In the form illustrated, a solar collector 510 is secured to the mullion 506 and is substantially coextensive therewith. In a preferred form, the solar collector 510 would have a width in the range of about 4 inches to 100% of the width of the mullion. The upper window 500 is secured between the mullion 506 and jambs 512, 514 and header 516. The lower window 502 is secured between the mullion 506, jambs 520, 522, and sill 524.

In the form shown in FIGS. 20 and 21, the framing members are vinyl extrusions although, if desired, other materials such as aluminum or fiberglass, for example, may be employed.

The solar panel 510 extends downwardly and outwardly from the mullion 506 and preferably has an included angle therebetween about 1 to 90 degrees with respect to the vertical.

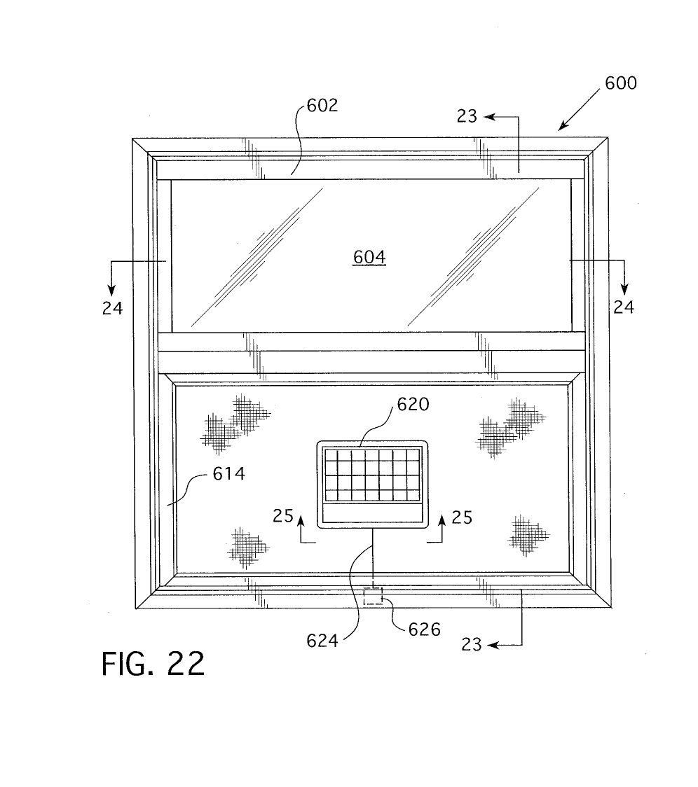

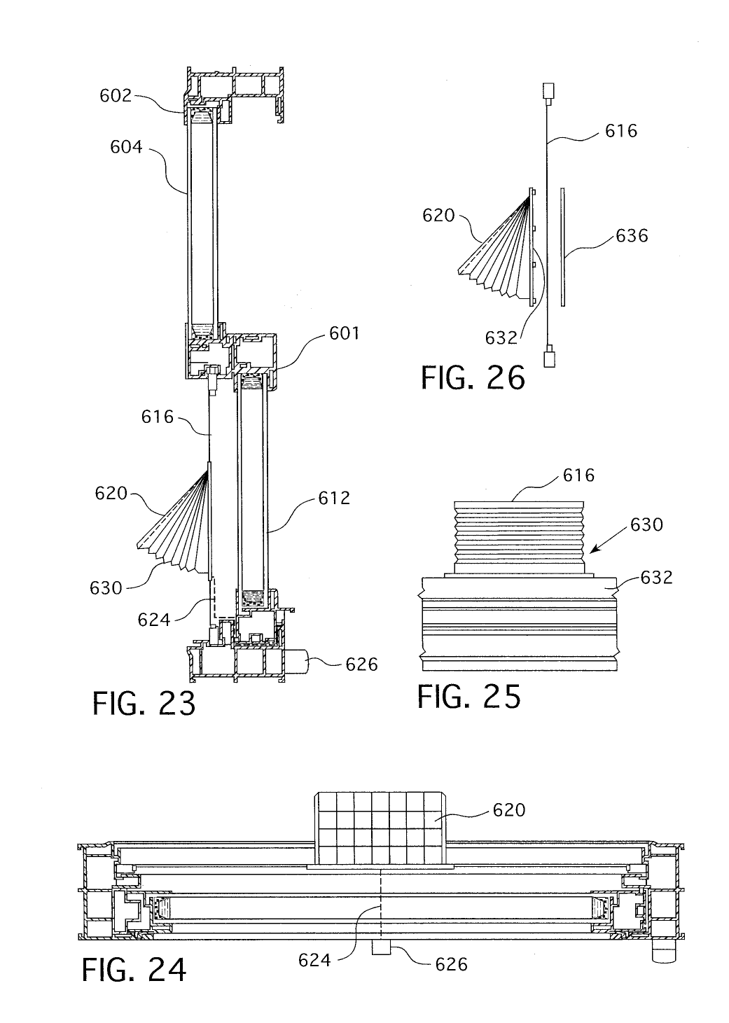

Referring to FIGS. 22-25, there is shown a single hung window 600 having a fixed upper lite 602 with a double pane glazing 604. A movable sash 601 has a double pane glazing 612. Secured within the frame 614 is a screen 616. A solar collector 620 projects outwardly and downwardly from the screen 616 to which it is secured. The solar collector which is secured to the exterior of the window-screen assembly has an electrical wire 624 and its associated storage battery which may be positioned on the interior of the window-screen assembly or within spaces on the inside of the assembly with the USB port being open rearwardly for access from the interior of the structure. In the form shown, a bellows 630 is secured to the underside of the solar collector 620 so as to resist undesired entry of insects into the region between the screen and rear surface of the solar collector 620.

Referring to FIGS. 26 through 28, a preferred manner of securing the solar collector 620 to the screen 616 will be considered. The solar collector 620 is secured to the bellows 630, which in turn is secured to base element 632 which is positioned exteriorly of the screen 616. Disposed on the inside of the screen is a support plate 636 which cooperates with base 632 in accepting securement of the solar collector 620 and bellows 630 to the screen. In this embodiment, which may advantageously be employed to retrofit a solar collector system into an existing window-screen assembly, the base member will have a plurality of rearwardly projecting posts, such as 640,642,644,646,648,650,652,654, which are distributed about the periphery of the rear surface of the support of the base 632.

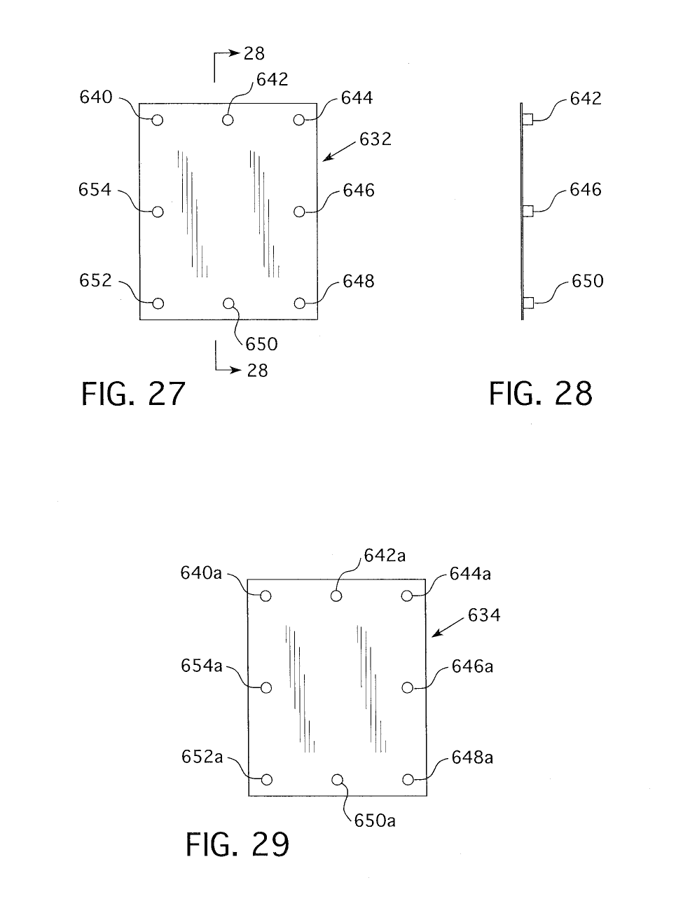

FIGS. 27 and 28 show the base 632 which has around its perimeter a plurality of outwarding projecting posts 640,642,644,646,648,650,652,654.

FIG. 29 has a plurality of openings 640a,642a,644a,646a,648a,650a,652a and 654a which correspond in dimension and position to the posts of FIG. 28. It will be appreciated that as shown in FIG. 26, the solar collector 620 and bellows 632 which are secured to base 632 are positioned on the exterior of screen 616 and cooperating support member 636 is positioned on the interior. By urging the two members 632,634 together, effective securement of the solar collector 620 to the screen 616 is effected. In a preferred embodiment, adhesive will be applied to the inward facing surface of base 630 or outward facing surface of member 634, or both, in order to provide for more intimate securement.

Referring to FIG. 29, there is shown a plurality of holes 640a,642a,644a,646a,648a,650a,652a and 654a which are so sized and positioned as to achieve intimate interfit with the posts shown in FIGS. 27 and 28. This will serve to effect intimate securement of the solar collector assembly to the screen.

Another feature of the present invention is a preferred structure which permits rotation of the solar collector, such that it may be shipped initially generally flush with the window or door to which it is attached and may be rotated outwardly to the an angle to permit more efficient receipt of the solar energy. In the present embodiment, selected for purposes of illustration, the solar collector is structured to have two positions. A first position is generally flush with the window or door to which it is secured, and a second position has the solar collector oriented generally downwardly and outwardly to provide a desired angle for exposure to the solar energy.

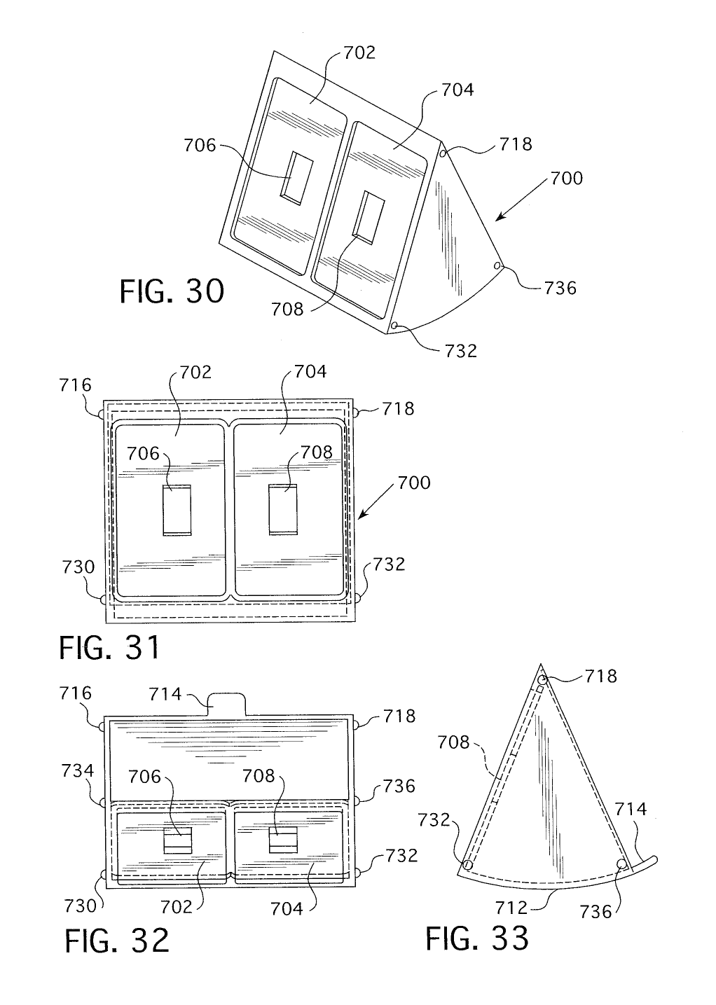

Referring to FIGS. 30 through 33, there is shown a generally wedged shaped solar collector support 700. The support has two recesses 702,704, each of which is structured to receive a solar collector (not shown). The recesses 702,704 have openings 706,708, respectively to permit electrical wires connected to the solar collectors deliver the electrical energy emerging from the solar collectors. The lower portion 712 of the solar collector support 700 is curved and has a projecting tab 714 which may be grasped to facilitate rotation of the solar collector. At the upper end of the solar collector support 700 are a pair of projecting bosses 716,718 which will serve when anchored within the frame as described herein as the pivots for rotation of the solar collector support. At the lower end of the solar energy support are two pairs of outwardly projecting bosses 730,732 and 734,736. The solar collector support 700, when secured to the frame as hereinafter described, can be pivoted about outwardly projecting bosses 716,718 which are engaged with detents (not shown in this view) of the frame. The solar collector support 700 may then, in the form shown, be positioned in a first position wherein the bosses 730,732 are engaged within detents and the solar collector is generally against the supporting surface, or a second position where the bosses 734,736 are engaged within the detents and the solar collector will be projecting outwardly and downwardly. It will be appreciated that additional bosses maybe provided in order to permit fixing the solar collector a number of different angles.

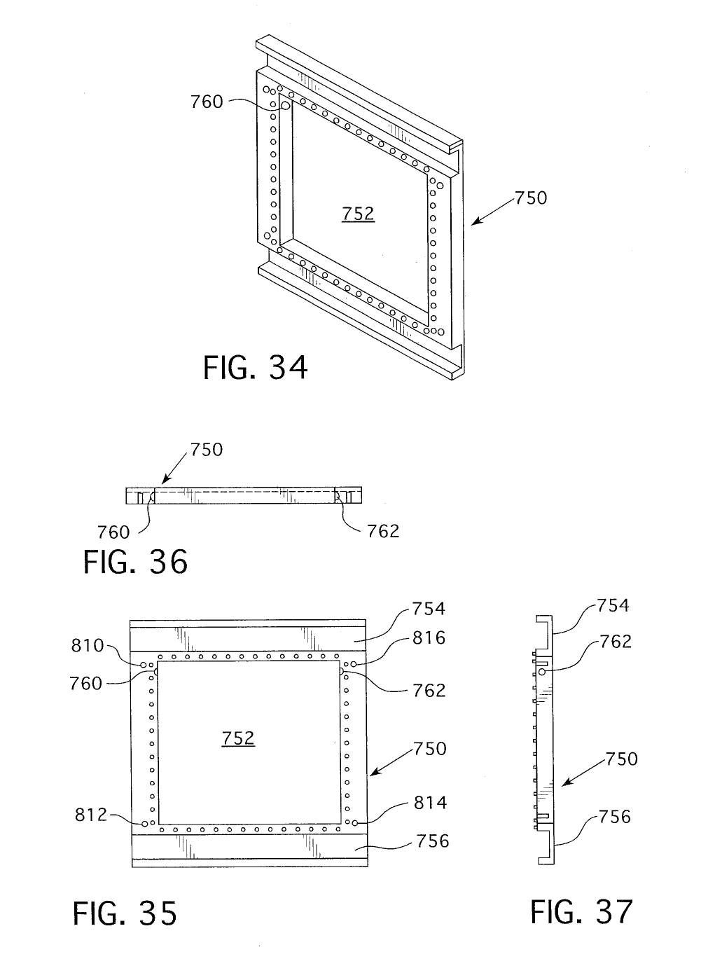

Referring to FIGS. 34 through 37, the frame element 750 has a central opening 752 and a pair of channels 754,756 located at the upper and lower extremities of the frame and having openings facing in generally the same direction. Toward an upper portion of the frame element 750 are a pair of detents 760,762 which are in communication with frame opening 752. The pivot bosses 716,718 of the solar collector support will be received in these detents 760,762 to permit ready rotation of the solar collector support with respect to the frame element 750.

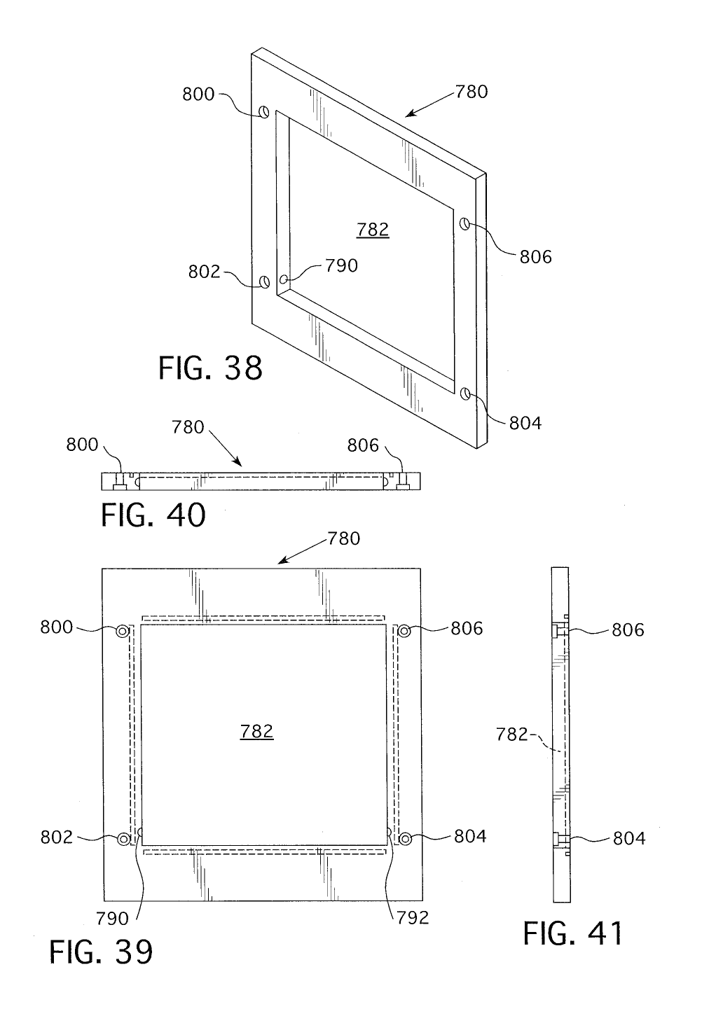

Turning to FIGS. 38 to 41, there is a frame element 780 which has opening 782 and detents 790, 792. It also has openings 800, 802, 804, 806.

Suitable mechanical fasteners such as properly sized screws may be employed to secure the two frame elements 750,780 together.

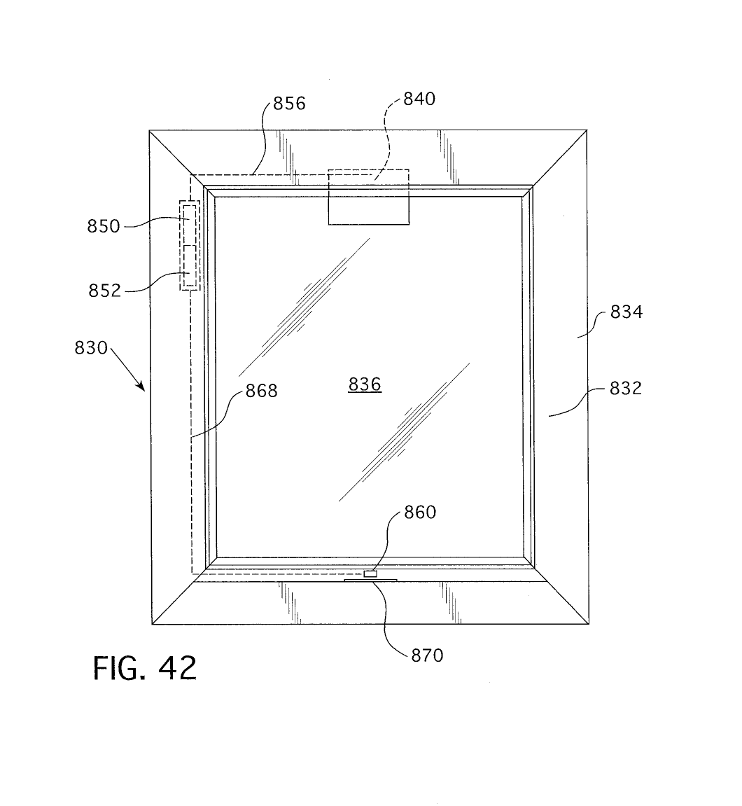

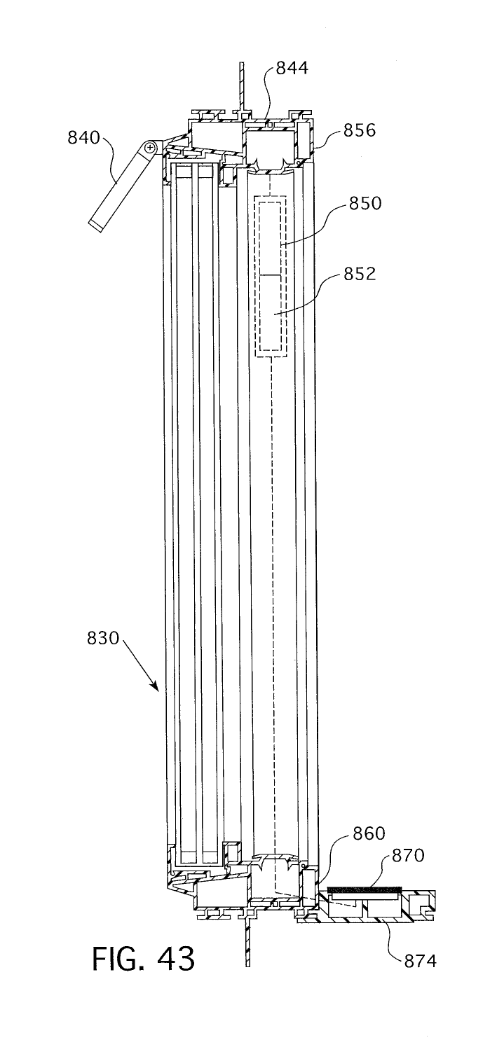

FIGS. 42 and 43 show a fixed window 830 having a frame 834 and double pane glazing 836 secured within the frame 832. A solar collector 840 extends downwardly and outwardly on the exterior of the window from an upper portion thereof adjacent header 844. A pair of storage batteries 850,852 are electrically connected through wire 856 to the solar collector and for receipt of electrical energy therefrom. Batteries 850,852 are connected to electrical outlet which in the form shown is a USB battery 860 through wire 868. In addition to permitting one to connect the charger with the electrical outlet 860 by inserting an appropriate jack therein, this embodiment of the invention provides a wireless charging pad 870 which will facilitate wireless charging of a device. In the form shown, the wireless charging device 870 is secured within the projecting sill 874. A devise to be charged would have an attachment which would complete the circuit when it comes in contact with the charging pad 870.

Referring to FIGS. 44 through 46, the rotatable solar collector 840 will be considered in greater detail. As shown in FIG. 44, the solar collector base 874 is secured to a portion of the window frame 876 by a pair of screws 878, 880 with the wire 882 emerging from the solar collector 840 passing extending through or under the base 874. The solar collector frame 884 has a pair of rearwardly extending legs 886, 887, each of which has a passageway 889, 890.

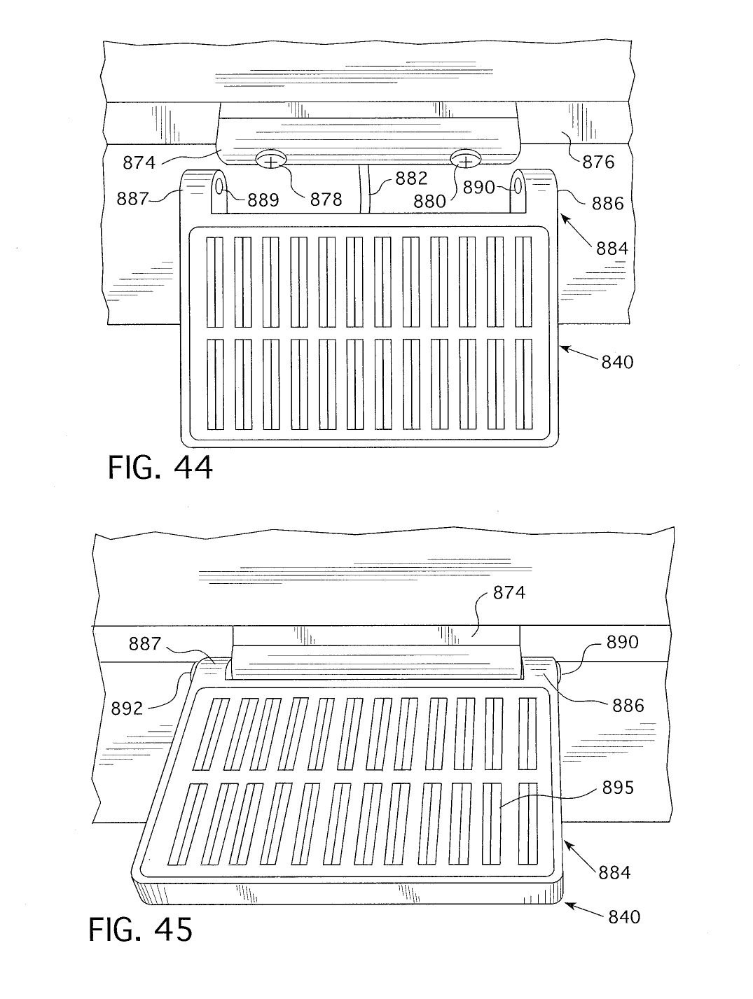

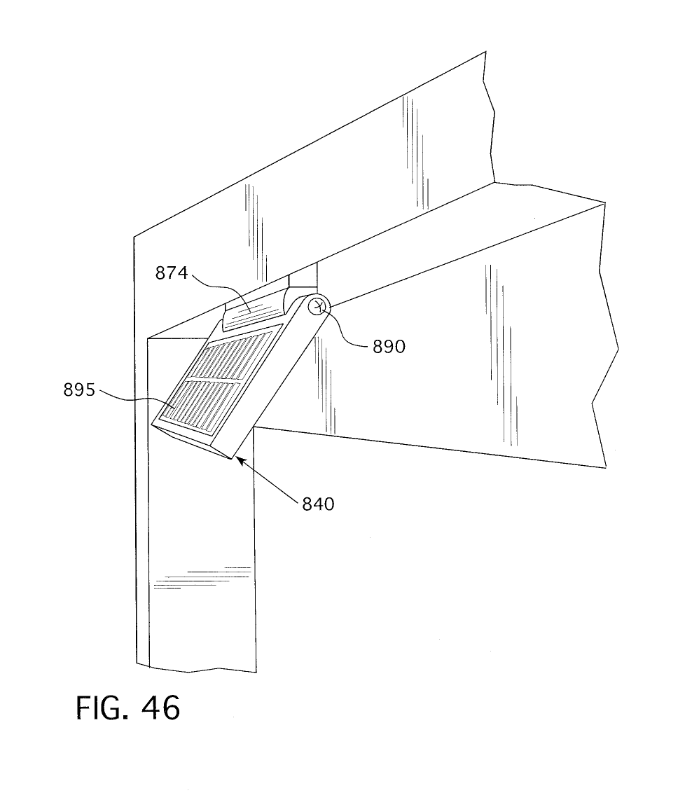

Referring to FIGS. 45 and 46, the legs 886, 887 are aligned with the solar collector frame 884 with mechanical fasteners such as screws 890, 892 passing through legs 886, 887 , respectively, and secured within base 874. The solar collector portion 895 is, therefore, rotatably secured to base 874.

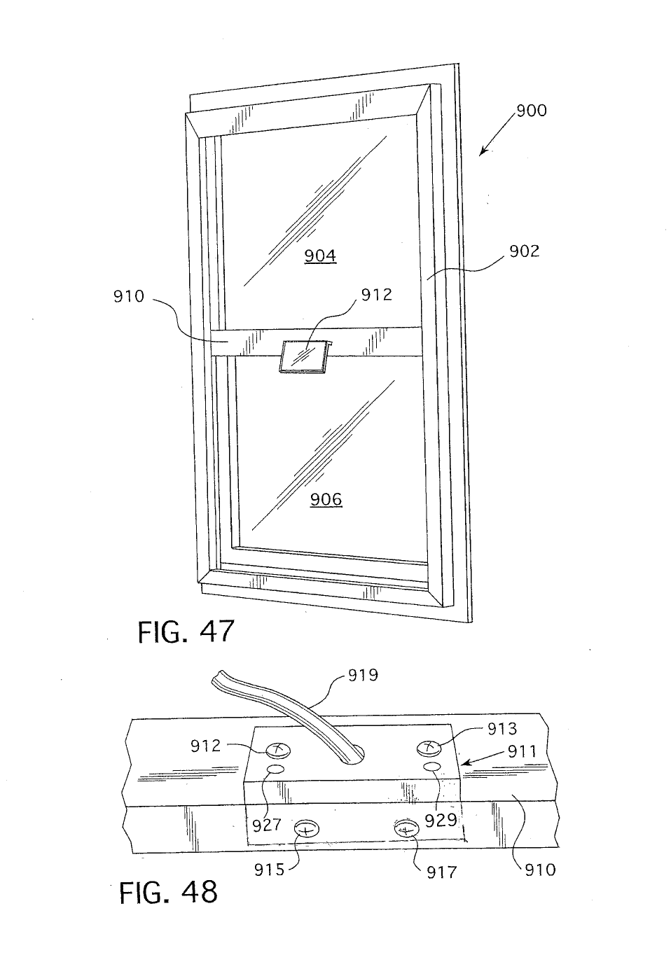

Referring to FIGS. 47 and 48, there is shown a mullion 910 to which is secured anchor member 911 which has two screws 912, 913 securing the anchor member 911 to one surface of mullion 910 and screws 915, 917 securing the anchor 911 to another surface of mullion 910. An electrical wire 919 extends through the anchor 911 to deliver electrical energy emerging from the solar collector 912 through the support 914 into mullion and therebeyond to the storage battery (not shown).

Referring to FIGS. 48 and 49, the solar collector support 914 has an opening 921 through which the wire 919 passes. Support 914 is secured to the anchor 911 by screws 923, 925 which respectively are received in openings 927, 929.

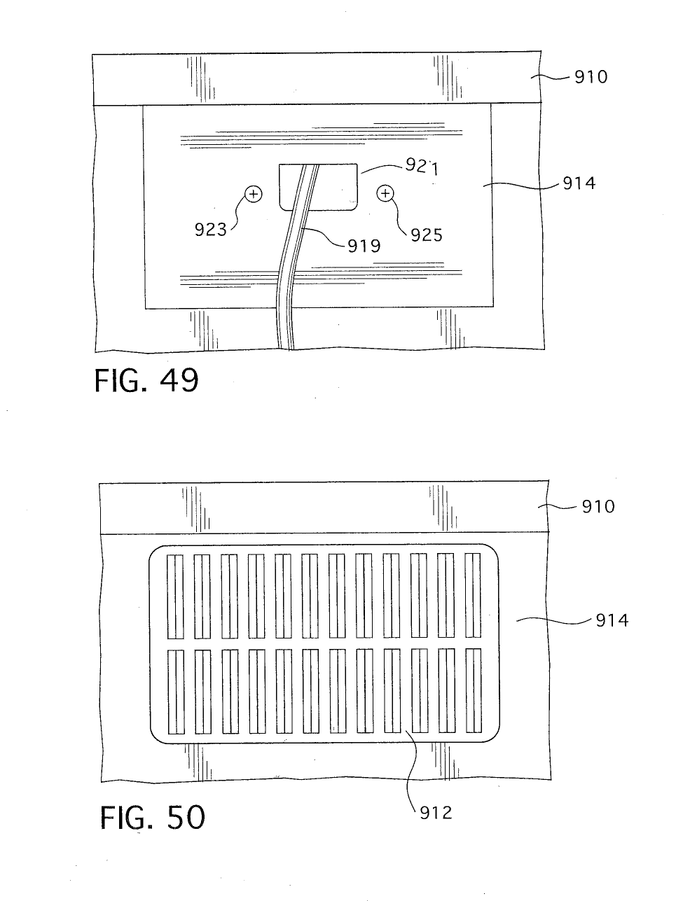

As shown in FIG. 50, the support 914 has the solar collector 912 secured to the outer face thereof as by a suitable adhesive.

The solar collector 912 is generally planar and is secured to a substantially rigid base 914. Fastening screws 920,922,924,926 secure the solar collector 912 and its substantially rigid support 914 to the mullion 910. This provides for a fixed angle solar collector.

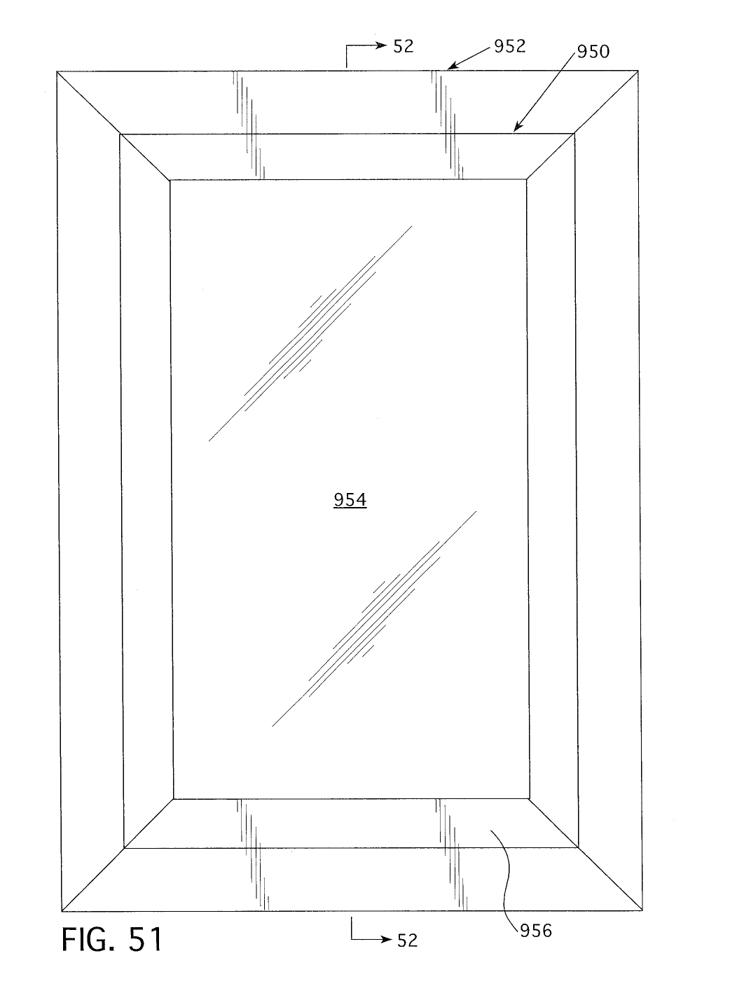

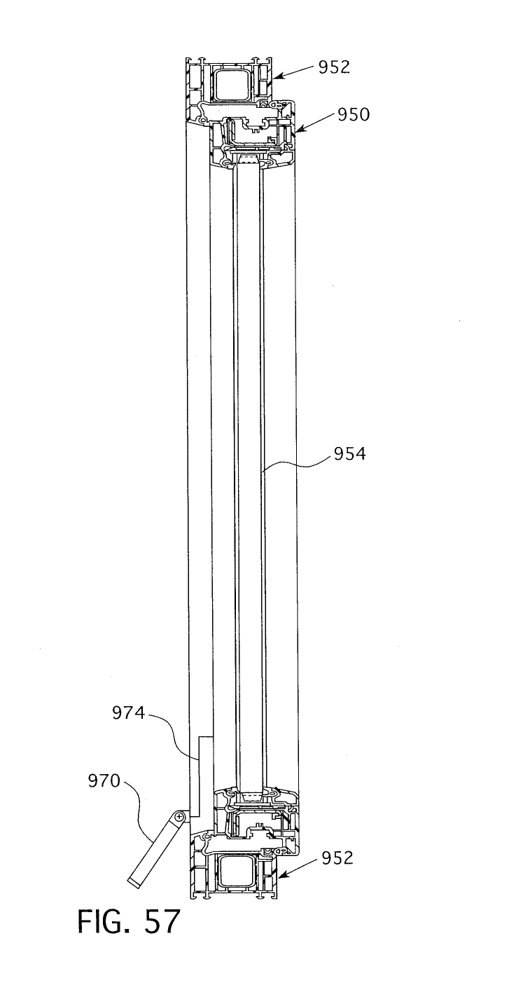

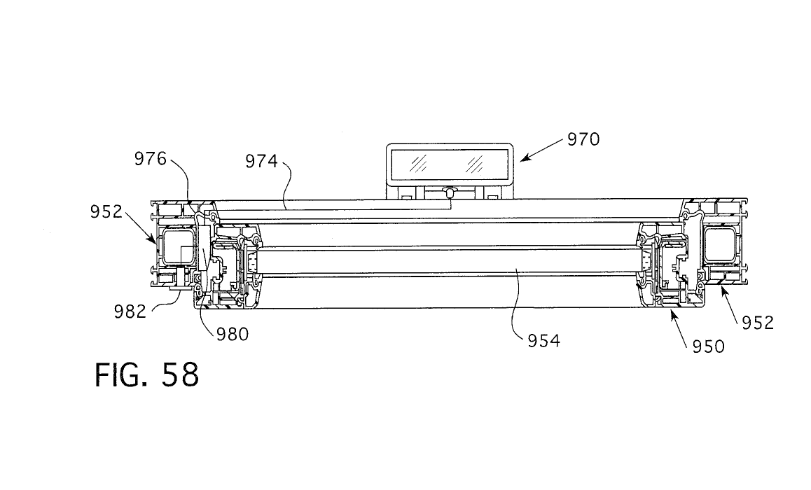

Referring to FIGS. 51-58, an additional embodiment of the invention will be considered. FIGS. 51-56 disclose a tilt and turn window which has a fixed frame and a moveable sash. In a first position, the window is closed. In a second position, the window is turned open as by rotation about a vertical axis, for example. In a third position which involves tilting with rotation about a horizontal axis, for example, establishing an opening of the desired angle with the opening facing generally upwardly for ventilation purposes. FIGS. 57 and 58 show a window of the type shown in FIGS. 51-56 provided with the solar collector, storage battery, USB port and associated wiring of the present invention. This embodiment provides for electrical energy obtained through the solar collector to be delivered to the battery for charging the same regardless of whether the window is in the closed, turned open or tilted position.

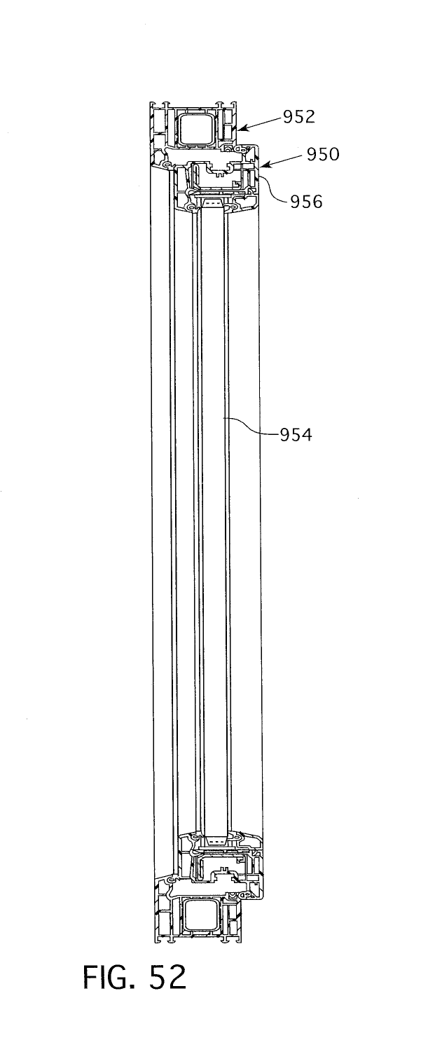

Referring to FIGS. 51 and 52, there is shown a sash 950 which is secured within window frame 952. The sash 950 has glazing 954 and sash frame 956. The tilt and turn window is shown in a first closed position. In the form illustrated, the two opening positions, i.e., turn open or tilt open, would result in rotational movement of the sash 950 toward the right as shown in FIG. 52.

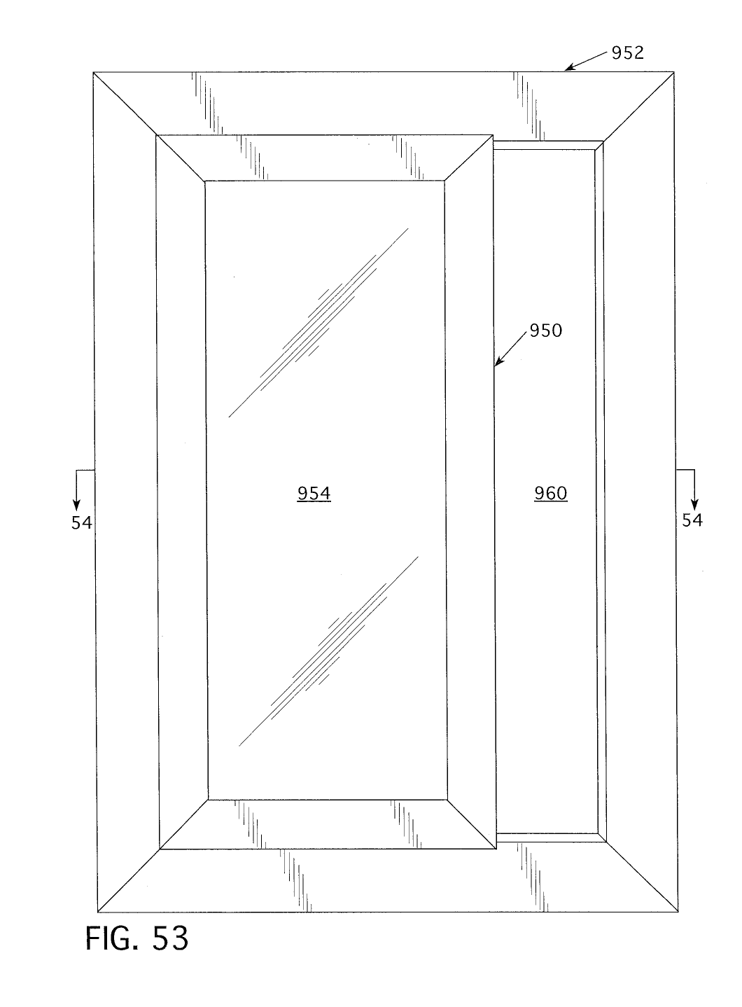

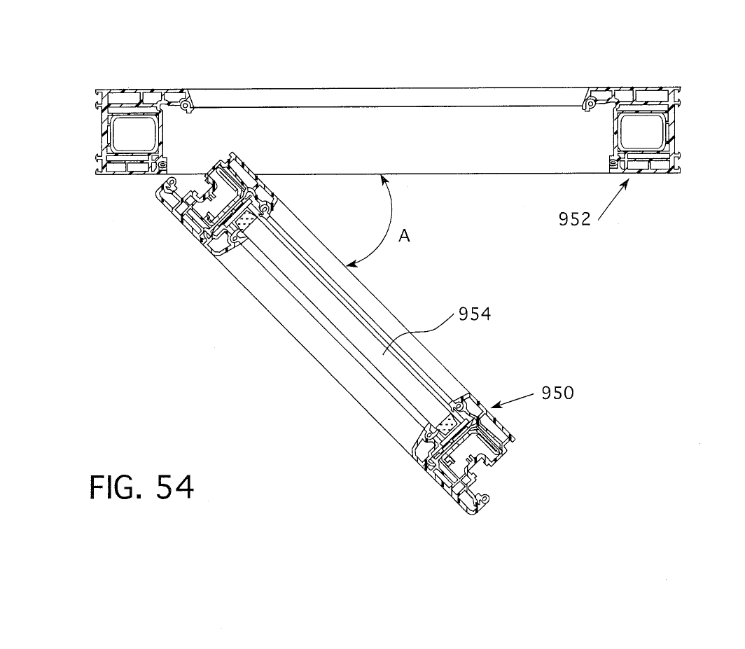

Referring to FIGS. 53 and 54, a second feature of the tilt and turn window is illustrated. In these figures, the window has been turned open by rotation about a vertical axis to establish the angle A between the sash 950 and window frame 952. This establishes opening 960. The hardware associated with grasping of the sash and the hinge and the like, will all be well known to those skilled in the art and, in the interest of simplicity and clarity of disclosure, have not been illustrated. In general, it will be preferred to have the sash 950 rotate toward the interior of the building. This approach not only facilitates attention to security issues, but also facilitates cleaning of the external surface of the window.

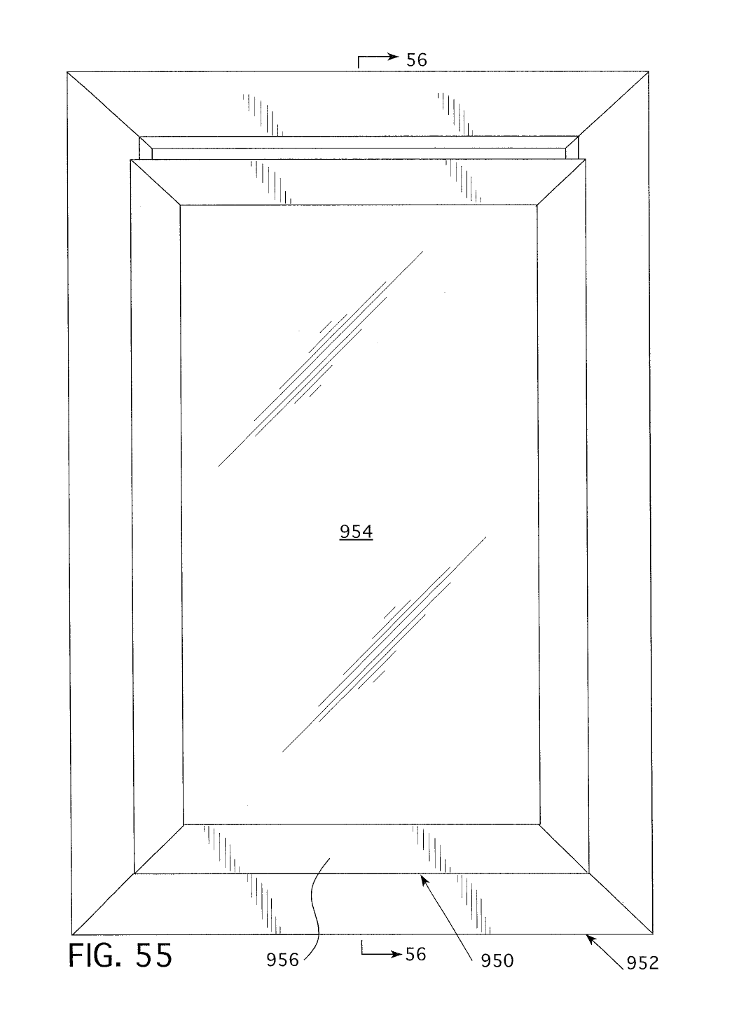

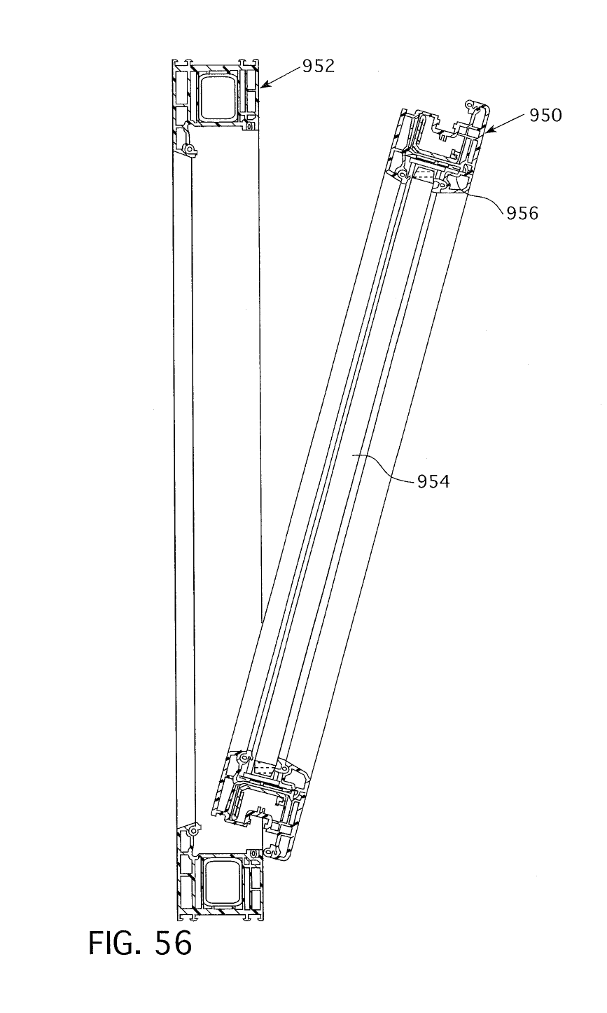

FIGS. 55 and 56 illustrate the third position involving the tilt function of the window. In this position, the sash 950 rotates about a lower portion to establish an opening which permits communication between the building exterior and interior for ventilation. In general, it will be preferred that in effecting the tilting action, the sash would be rotated toward the interior of the building.

Referring to FIGS. 57 and 58, there is shown in FIG. 57 a cross-sectional illustration similar to FIG. 52 with the window in the closed position, but with the solar collector battery, USB port and connecting electrical components shown. FIG. 58 is a horizontal cross-section showing the solar collector and associated components as applied to the tilt and turn window. The sash 950 and frame 952 are shown in closed position. The solar collector 970 which may, for example, be of the type disclosed hereinbefore, is secured to a portion of frame 952 which, in the form shown, is a lower portion of the frame, if desire, it could be secured to other portions of the frame 952. In the form shown, solar collector 970 extends angularly, outwardly and downwardly. A wire 974 is connected to the solar collector 970 and, as shown, in FIG. 58, extends into a portion 976 of the frame 952 and is connected to battery 980 for charging the same. The battery 980 is operatively associated with USB port 982 which faces the interior of the building in the form shown. It will be appreciated that the solar collector 970 is operatively associated through wire 974 with battery 980, which in turn, will be operatively associated with USB port 982 to facilitate charging whatever device it is desired to charge.

While the embodiment of FIGS. 51-58 have been disclosed with use in windows, it will be appreciated that it may be employed with doors as well.

It will be appreciated that for many installations, it will be preferred to have the solar collector rigid or substantially rigid. In some instances it will be preferred to have the solar collector flexible so as to conform to the profile of an adjacent structure, for example.

It will be appreciated, therefore, that the present invention provides unique constructions facilitating the energy efficient charging of storage batteries which in turn are structured to energize various devices through power outlets, such as USB power outlets, disposed interiorly of the building. The connections between the solar collector and the battery being charged are preferably through wires which pass through hollow structural portions of the window and door framing, and are so structured as to not interfere with normal functioning of the windows and doors, particularly with references to those which have moving sashes. In the alternative, a window or door frame and sash can complete a circuit or a screen and frame can complete a circuit. A window or door frame may be in a first position with the contacts touching to complete the circuit and break the circuit when the window or door is in a second position. Such a construction may be employed in casement windows as well as other types of windows and doors with one contact electrically connected to the solar collector and the other contact electrically connected to the storage battery such as, for example tilt and turn windows. The circuit can also be completed by rotating sashes and electrical contacts positioned appropriately. The systems are designed to be employed with factory manufactured products, retrofit products and field adjustments.

If desired, the component parts such as the solar collectors, batteries, USB ports and other electrical components, for example, may be provided with quick connect features to facilitate rapid replacement of parts. If desired, the USB ports may be retractable.

The windows and doors of the present invention also permit positioning of the solar collectors and portions of the system in a wide variety of locations. The solar collectors depending upon design preference, may be secured to the glass, a frame, a sash or a screen, for example. They may also be secured, for example, to fresh air ventilators. In certain embodiments, the solar collector would be secured to screens rather than directly to portions of the windows. In other embodiments, the storage battery being charged may be positioned inside the window or door for direct interior access to the power outlets, or closely adjacent to the solar collector with appropriate electrical connection from the storage battery to the power outlets. The system may be employed with a wide variety of residential and commercial windows and doors of the fixed or movable sash variety. It also may be employed with windows and doors made of aluminum, steel, vinyl, fiberglass composites and other suitable materials.

Whereas particular embodiments of the invention have been described herein for purposed of illustration, it will be evident to those skilled in the art that numerous variations of the details may be made without departing from the invention as set forth in the appended claims.

The invention claimed is:

1. A window having an integral energy collector and charging system comprising, said window having a moveable first sash being structured to move between a window open position and a window closed position.
a solar collector secured to the exterior of a generally horizontal framing member of said window,
said solar collector extending generally outwardly and downwardly from said framing member,
an electrical conductor operatively associated with said solar collector passing through said generally horizontal framing member,
an electrical outlet accessible on the interior of said window, and
a storage battery electrically connected to both said solar collector said electrical outlet, whereby solar energy collected by said solar collector will be transformed into battery charging electrical energy with said battery being structured to charge a device plugged into said electrical outlet.

2. The window of claim 1 including,
a second sash disposed at a higher level than said first sash, and
said storage battery and said electrical outlet being disposed at a level lower than said first sash.

3. The window of claim 1 including
said window being a single hung window.

4. The window of claim 1 including,
said solar collector having an upper portion being rotatably mounted with respect to said framing member in order to adjust the angle of said solar collector.

5. The window of claim 1 including,
said electrical outlet being a USB port.

6. The window of claim 1 including,
said electrical conductor passing through said horizontal framing member to which said solar panel is secured and down through a jamb adjacent said storage battery.

7. The window of claim 1 including,
said solar collector cooperating with a bellows to resist undesired entry of insects into said window frame.

8. The window of claim 1 including,
said movable sash being structured to move in a generally vertical direction .

9. The window of claim 1 including,
said movable first sash being structured to move in a generally horizontal direction.

10. The window of claim 1 including,
said solar collector being rotatably mounted with respect to said window.

11. The window of claim 1 including,
said solar collector being adhesively secured to the exterior of said window.

12. The window of claim 1 including,
said window having frames made of hollow extrusions.

13. The window of claim 1 including,
said extrusions being made from a material selected from the group consisting of aluminum, vinyl and fiberglass.

14. The window of claim 13 including,
said extrusions being aluminum extrusions.

15. The window of claim 1 including,
a tamperproof enclosure positioned around portions of the exterior of said solar collector so as to resist undesired tampering with said solar collector without substantially reducing the amount of solar energy impinging on the solar collector.

16. A window having an integral energy collector and charging system comprising,
said window having a movable first sash being structured to move between a window open position and a window closed position.
a solar collector secured to the exterior of a generally vertical framing member of said window, said solar collector extending generally outwardly and downwardly from said framing member, an electrical conductor operatively associated with said solar collector passing through said generally vertical framing member,
an electrical outlet accessible on the interior of said window, and
a storage battery electrically connected to both said solar collector by said electrical conductor and said electrical outlet, whereby solar energy collected by said solar collector will be transformed into said storage battery as electrical energy and with said battery being structured to charge a device plugged into said outlet.

17. The window of claim 16 including,
said storage battery disposed exteriorly of said generally vertically framing member and rearwardly of said solar collector.

18. The window of claim 16 including,
said electrical conductor having a first portion connected to said solar collector and said storage battery and a second portion passing through said generally vertical framing member connected to said power outlet.

19. The window of claim 17 including,
a tamperproof enclosure positioned around portions of the exterior of said solar collector so as to resist undesired tampering with said solar collector without substantially reducing the amount of solar energy impending on the solar collector,

20. The window of claim 16 including,
said solar collector having an upper portion rotatably mounted with respect to said framing member in order to adjust the angle of said solar collector.

21. The window of claim 16 including
said power outlet being a USB port.

22. The window of claim 16 including
said solar collector disposed exteriorly of said vertical framing member, and
said power outlet projecting rearwardly from the interior surface of said framing member.

23. A window having an integral energy collector and charging system comprising,
said window having a movable sash and a surrounding fixed frame,
said window being a casement window being structured to have a sash rotate responsive to operation of a crank,
a solar collector secured to the exterior of said sash,
an electrical conductor operatively associated with said solar collector and passing through a frame of said casement window,
a storage battery operatively associated with said electrical conductor, and
an electrical outlet secured to an internal portion of said fixed frame and being accessible from the interior of said window.

24. The window of claim 23 including,
said solar collector secured to the window portion of said sash.

25. The window of claim 23 including,
said electrical conductor passing through said sash and down through a jamb adjacent said storage battery.

26. The window of claim 23 including,
said electrical outlet being a USB port.

27. The window of claim 23 including,
said moveable sash being structured to rotate about a generally vertical axis.

28. The window of claim 23 including,
said movable sash being structured to rotate about a generally horizontal axis.

29. The window of claim 23 including,
said electrical conductor passing through the sash frame to the jamb and passing internally therethrough to connect with said storage battery,
said sash having upper and lower rails connected to a pair of vertically oriented frame members, and
said solar collector disposed adjacent the lower said rail.

30. The window of claim 23 including,
said solar collector having an upper portion secured to said sash and extending downwardly and outwardly therefrom.

31. The window of claim 23 including,
the included angle between said solar collector and the adjacent said sash to which it is secured being about 1 to 90 degrees.

32. The window of claim 23 including,
a housing containing said storage battery and said power outlet.

33. A window assembly having an integral energy collection and charging system comprising,
a window having a sash with a cooperating window sill,
a storage battery electrically connected to a power outlet which is secured to an interior portion of said window sill,
a screen having a frame,
a solar collector panel secured to the exterior of said screen,
an electrical conductor connected to said solar collector extending downwardly through a screen frame and into said window sill and extending longitudely therealong, and
said electrical conductor being electrically connected to said storage battery for energizing the same.

34. The window of claim 33 including,
said solar collector being disposed within the lower half of said screen.

35. The window of claim 33 including,
said solar collector being generally rectangular and having a pair of generally parallel lateral frame elements having a lower end secured to a screen sill and an upper end secured to a screen rail.

36. The window of claim 33 including,
said solar collector occupying about 1 to 90 percent of the overall area of the screen mesh.

37. The window of claim 33 including,
said window having a pair of vertically stacked sashes with each sash having a fixed lite.

38. The window of claim 33 including,
said electrical outlet has a plurality of USB ports.

39. The window of claim 33 including,
said solar panel extending outwardly and downwardly in order to assume a position with the included angle between the plane of the screen and the solar panel of about 1 to 90 degrees.

40. A window assembly having a integral energy collecting and charging system comprising
a first fixed lite window overlying a second fixed lite window with a mullion disposed therebetween,
a solar collector panel secured to the exterior of said mullion,
a storage battery and power outlet secured to the interior of said mullion,
an electrical conductor connecting said solar panel with said storage battery, and
said storage battery operatively associated with said power outlet to energize the same.

41. The window of claim 40 including,
said solar collector panel extending greater than 50% of the length of said mullion.

42. The window of claim 41 including,
said solar panel having a length generally co-extensive with said mullion.

43. The window of claim 40 including,
said solar panel being generally planar and having a smaller included angle of about 1 to 90 degrees with respect to the vertical.

44. The window of claim 40 including,
said mullion being composed of at least one aluminum extrusion.

45. The window of claim 40 including,
Said storage battery and power outlet projecting rearwardly out of the interior of said mullion.

46. A door assembly having an integral energy collection and charging system comprising,
a door frame having a pair of jambs, a header and a sill,
a door panel rotatably mounted with respect to said door frame,
at least one solar collector secured to the exterior of said rotatable door panel,
at least one power outlet secured to the interior of said door,
an electrical connector connecting each said solar collector to a said power outlet,
at least one solar collector secured to the exterior of said door frame,
a power outlet secured to said door frame,
a storage battery operatively associated with said power outlet secured to said door frame, and
an electrical conductor connecting said solar collector to said storage battery.

47. The door assembly of claim 46 including,
said rotatable door panel having a pair of solar collectors secured to the exterior thereof.

48. The door assembly of claim 47 including,
a first said solar collector secured to an upper portion of said rotatable door panel, and
a second said solar collector secured to a lower portion of said sash rotatable door panel.

49. The door assembly of claim 46 including,
sash door jambs being hollow aluminum extrusions, and
said electrical conductor extending from said door frame solar collector through the hollow interior of a said door jamb to said storage battery.

50. The door assembly of claim 46 including,
said door panel solar collectors having an upper portion secured to the door panel and extending angularly downwardly and outwardly.

51. The door assembly of claim 49 including,
said door frame solar collectors extending downwardly and outwardly from the door frame.

52. The door assembly of claim 46 including,
said rotatable door panel structured to rotate toward the exterior.

53. A window having integral energy collector and charging system comprising
said window having at least one window sash and a window frame,
at least one solar collector secured to the exterior of at least one of said sash frame and said window frame,
said solar collector extending outwardly and downwardly from said framing member,
said solar collector being rotatably mounted for positioning in a first position at a first angle with respect to said window and a second position at a second angle with respect to said window,
said solar collector in at least one of said positions extending generally outwardly and downwardly from said window,
an electrical conductor operatively associated with said solar collector,
an electrical outlet accessible on the interior of said window and a storage battery electrically connected to both said solar collector and said electrical outlet,
whereby solar energy collected by said solar collector will be transformed into battery charging electrical energy with said battery being structured to charge a device plugged into said electrical outlet.

54. The window of claim 53 including
said solar collector having a frame member and a solar collector mounting member operatively associated therewith for facilitating rotation between two solar collector fixed positions.

55. The window of claim 54 including
said solar collector support member having a pair of outwardly projecting bosses rotatably secured within a pair of detents in said frame member,
whereby said solar collector support member may be rotated with respect to said frame.

56. The window of claim 55 including
said solar collector support member being generally wedge-shaped and having said pivot bosses disposed adjacent the upper edge thereof,
a lower portion of said solar collector support member having two pairs of spaced outwardly projecting bosses, each structured to engage sequentially a pair of detents in said frame with a first pair of said lower bosses structured to engage said frame detents, placing said solar collector in a first position and said second lower pair of bosses engaging said pair of detents positioning said solar collector in a second position.

57. The window of claim 56 including
said solar collector support member having an opening for passage of a wire from said solar collector to said storage battery.

58. The window of claim 57 including
said frame being fixedly secure to said window.

59. A support for fixedly securing a solar panel to a window or door framing member comprising a solar panel support,
a generally L-shaped securing member having a first wall secured to said solar panel support, mechanical fasteners passing through said first wall for engaging and securing said solar panel collector support to said framing member,
a lower wall of said securement member oriented generally perpendicular with respect to the first wall and having mechanical fasteners for engaging another portion of said frame for engaging and securing said support to said framing member.

60. The window of claim 59 including
said support structured to fixedly secure said solar collector in a specific angular position with respect to said frame.

61. The window of claim 60 including
said solar collector support being structured to have a solar collector secured thereto on the side opposite said securing member.

62. A window or door having an integral energy collector and charging system comprising,
said window or door having a moveable first sash being structured to move between an open position and a closed position.
a solar collector secured to the exterior of a framing member of said window or door,
said solar collector extending generally outwardly and downwardly from said framing member, an electrical conductor operatively associated with said solar collector extending into said framing member,
an electrical outlet accessible on the interior of said window,
a wireless charging pad disposed closely adjacent to the electrical outlet, and
a storage battery electrically connected to both said solar collector said electrical outlet, whereby solar energy collected by said solar collector will be transformed into battery charging electrical energy with said battery being structured to charge a device plugged into said electrical outlet.

63. The window or door of claim 62 including
said framing member being a framing member of a window.

64. The window or door of claim 62 including
said framing member being a framing member of a door.

65. The window or door of claim 62 including
said solar collector being structured to be secured within at least two different angular positions with respect to said framing member.

66. A window or door having an integral energy collector and charging system comprising
said window or door having a moveable sash and a frame,
said sash structured to assume a first position wherein the window or door is closed, a second position wherein the sash is rotated about a generally vertical axis to create an open position, and a third position wherein the sash is rotated about a generally horizontal axis in order to create a tilt position,
a solar collector secured to the exterior of said frame,
said solar collector extending generally outwardly and downwardly from said frame,
an electrical conductor operatively associated with said solar collector passing through said frame,
a storage battery electrically connected to said solar collector by said electrical conductor,
an electrical outlet electrically connected to said storage battery, and
said system functioning independently of whether said window or door is in said first position, second position or third position.

67. The window or door of claim 66 including
said frame being the frame of a window.

68. The window or door of claim 66 including
said frame being the frame of a door.

69. The window or door of claim 66 including
said solar collector being structured to be secured in at least two different angular positions with respect to said frame.

70. The window or door of claim 66 including
said sash when moved to said third position rotating toward the interior of the structure to which it is secured.

71. The window or door of claim 70 including
said sash when moved to said second position rotating toward the interior of the structure to which it is secured.

72. The window or door of claim 66 including
said electrical conductor, said storage battery and said electrical outlet, all disposed exteriorly of said sash.

73. The window or door of claim 72 including
said electrical outlet being a USB port.

74. The window or door of claim 66 including
said frame and the frame of said sash composed of a material selected from the group consisting of aluminum, steel, vinyl and fiberglass,

75. The window of door of claim 66 including
said solar collector secured to a lower portion of said frame.

76. The window or door of claim 70 including
said solar collector disposed on the exterior of said structure.

77. The window or door of claim 73 including
said USB port being retractable.

78. The window or door of claim 76 including
said electrical outlet being accessible in the interior of said structure.
